(19) United States
(12) Patent Application Publication
(10) Pub. No.: US 2018/0174106 A1
(43) Pub. Date: Jun. 21, 2018

(54) FINDING VIRTUAL TEAMS WITH MEMBERS THAT MATCH A USER'S PROFESSIONAL SKILLS

(71) Applicant: LinkedIn Corporation, Sunnyvale, CA (US)

(72) Inventors: Krishnaram Kenthapadi, Sunnyvale, CA (US); Kaushik Rangadurai, Sunnyvale, CA (US)

(21) Appl. No.: 15/379,686

(22) Filed: Dec. 15, 2016

(51) Int. Cl. G06Q 10/10; G06Q 10/06; G06Q 50/00; G06N 99/00

(52) U.S. Cl. CPC G06Q 10/1053; G06Q 10/063112; G06F 3/0485; G06N 99/005; G06Q 50/01

(57) ABSTRACT

Methods, systems, and computer programs are presented for finding a virtual team in a company based on the skills of a member in the social network, such that the virtual team members have similar skills to the member. One method includes an operation for generating skill metrics for members of a social network. A request by a first member is detected for presentation of information about a company, and a similarity value between the first member and employees of the company that are members of the social network is calculated. The similarity value is based on a comparison of the skill metrics of the first member with the skill metrics of each employee. A virtual team of a plurality of employees having the similarity value above a predetermined threshold is identified, and the virtual team is presented in a user interface of the first member.

### TECHNICAL FIELD

The subject matter disclosed herein generally relates to methods, systems, and programs for finding virtual teams related to a job posting.

### BACKGROUND

Some social networks provide job postings to their members. A member may perform a job search by entering a job search query, or the social network may suggest jobs that may be of interest to the member. However, current job search methods may miss valuable opportunities for a member because the job search engine limits the search to specific parameters. For example, the job search engine may look for matches of a job in the title to the member's title, but there may be quality jobs that are associated with a different title that would be of interest to the member.

Further, existing job search methods may focus on the job description or the member's profile, without considering the member's preferences for job searches that go beyond the job description or other information that may help find the best job postings for the member.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a network architecture, according to some example embodiments, including a social networking server.

FIG. 2 is a screenshot of a user interface that includes job recommendations, according to some example embodiments.

FIG. 3 is a screenshot of a user's profile view, according to some example embodiments.

FIG. 4 is a diagram of a user interface, according to some example embodiments, for presenting job postings to a member of a social network.

FIG. 5 is a detail of a group area in the user interface of FIG. 4, according to some example embodiments.

FIG. 6 is a diagram of a user interface, according to some example embodiments, for presenting a virtual team associated with a job posting.

FIG. 7 is a diagram of a user interface, according to some example embodiments, for presenting a virtual team within a company page.

FIG. 8 illustrates data structures for storing job and member information, according to some example embodiments.

FIG. 9 illustrates the training and use of a machine-learning program, according to some example embodiments.

FIG. 10 illustrates a method for identifying similarities among member skills, according to some example embodiments.

FIG. 11 illustrates a method for presenting a virtual team, according to some example embodiments.

FIGS. 12A-12B illustrate the scoring of a job for a member, according to some example embodiments.

FIG. 13 illustrates a method for selecting jobs for presentation within a group, according to some example embodiments.

FIG. 14 illustrates a social networking server for implementing example embodiments.

FIG. 15 is a flowchart of a method, according to some example embodiments, for finding a virtual team in a company based on the skills of a member in the social network, such that the virtual team members have similar skills to the member.

FIG. 16 is a flowchart of a method, according to some example embodiments, for searching job postings for a member of a social network based on the strength of virtual teams at the companies offering the jobs.

FIG. 17 is a block diagram illustrating an example of a software architecture that may be installed on a machine, according to some example embodiments.

FIG. 18 is a diagrammatic representation of a machine in the form of a computer system within which a set of instructions may be executed for causing the machine to perform any one or more of the methodologies discussed herein, according to an example embodiment.

### DETAILED DESCRIPTION

Example methods, systems, and computer programs are directed to finding a virtual team in a company based on the skills of a member in the social network, such that the virtual team members have similar skills to the member. Further, methods, systems, and computer programs are directed to searching job postings for a member of a social network based on the strength of virtual teams at the companies offering the jobs.

Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Most job seekers wonder how well they will fit in a new job. For example, a job seeker may wonder if she has the qualifications for the job and how she would compare to the people who have the job today. i.e., the people of the team that she would join if she took the job. This is why it is valuable for the job seeker to learn more about the background and qualifications of people who have the job today.

Some example embodiments present to the job seeker one or more of the employees, in the company offering the job, that currently are in the same, or similar, job role as described in the job posting. These employees are referred to herein as the virtual team; snippets are presented to the job seeker with information about the virtual team members, such as name, qualification, and background.

As used herein, a virtual team, defined for a member, is a group of people working at the same company that have professional skills similar to the professional skills of the member. The people in the virtual team are referred to herein as the virtual team members, or simply the team members. The virtual team may include zero or more people, depending on how many people in the company match the skills of the member. In some cases, the virtual team includes people that work on a product that is similar to the product that the member is working on.

Further, in some embodiments, the virtual team may be limited to a predetermined maximum number of virtual team members for presentation to the member. The virtual team may be presented, for example, to the member in the social network when the member is accessing company information or when the member is getting information for a job posted by the company.

One of the goals of the present embodiments is to personalize and redefine how job postings are searched and presented to job seekers. Another goal is to explain better why particular jobs are recommended to the job seekers. The presented embodiments provide both active and passive job seekers with valuable job recommendation insights, thereby greatly improving their ability to find and assess jobs that meet their needs.

Instead of providing a single job recommendation list for a member, embodiments presented herein define a plurality of groups, and the job recommendations are presented within the groups. Each group provides an indication of a feature that is beneficial to the member for selecting jobs from the group, such as how many people have transitioned from the university of the member to the company of the job, who would be a virtual team for the member if the member joined the company, etc.

Embodiments presented herein define a virtual-team group that presents jobs to the member based on the strength of the virtual teams in the different companies, where the strength of the virtual teams is calculated based on the professional curriculum (e.g., professional skills or accomplishments) of the virtual team members.

One general aspect includes a method including operations for generating skill metrics for members of a social network, and for detecting a request by a first member for presentation of information about a company. The method further includes calculating a similarity value between the first member and employees of the company that are members of the social network, the similarity value being based on a comparison of the skill metrics of the first member with the skill metrics of each employee. The method also includes identifying a virtual team of a plurality of employees having the similarity value above a predetermined threshold, and causing presentation of the virtual team in a user interface of the first member.

One general aspect includes a system including a memory including instructions and one or more computer processors. The instructions, when executed by the one or more computer processors, cause the one or more computer processors to perform operations including generating skill metrics for members of a social network; detecting a request by a first member for presentation of information about a company; calculating a similarity value between the first member and employees of the company that are members of the social network, the similarity value being based on a comparison of the skill metrics of the first member with the skill metrics of each employee; identifying a virtual team of a plurality of employees having the similarity value above a predetermined threshold; and causing presentation of the virtual team in a user interface of the first member.

One general aspect includes a non-transitory machine-readable storage medium including instructions that, when executed by a machine, cause the machine to perform operations including generating skill metrics for members of a social network; detecting a request by a first member for presentation of information about a company; calculating a similarity value between the first member and employees of the company that are members of the social network, the similarity value being based on a comparison of the skill metrics of the first member with the skill metrics of each employee; identifying a virtual team of a plurality of employees having the similarity value above a predetermined threshold; and causing presentation of the virtual team in a user interface of the first member.

Another general aspect includes a method including an operation for identifying, by a server having one or more processors, a plurality of jobs for presentation to a first member of a social network. A profile of the first member includes professional information about the first member, each job being associated with a respective company, and each job having a job affinity score based on a comparison of data of the job and the profile of the first member. The method also includes, for each company, identifying a virtual team of members from the social network working on the company, the virtual team members being identified based on a similarity coefficient between the professional information of the first member and the professional information of the virtual team member. The method also includes operations for determining a virtual team score based on a professional score for each virtual team member, the professional score being based on the professional information of the virtual team member, and for ranking, by the server, the jobs based on the virtual team score of the company of the job and the job affinity score. The method also includes an operation for causing, by the server, presentation of a group including one or more of the ranked jobs in a user interface of the first member based on the ranking.

One general aspect includes a system including a memory including instructions and one or more computer processors. The instructions, when executed by the one or more computer processors, cause the one or more computer processors to perform operations including identifying, by a server having one or more processors, a plurality of jobs for presentation to a first member of a social network, a profile of the first member including professional information about the first member, each job being associated with a respective company, each job having a job affinity score based on a comparison of data of the job and the profile of the first member; for each company, identifying a virtual team of members from the social network working on the company, the virtual team members being identified based on a similarity coefficient between the professional information of the first member and the professional information of the virtual team member; determining a virtual team score based on a professional score for each virtual team member, the professional score being based on the professional information of the virtual team member; ranking, by the server, the jobs based on the virtual team score of the company of the job and the job affinity score; and causing, by the server, presentation of a group including one or more of the ranked jobs in a user interface of the first member based on the ranking.

One general aspect includes a non-transitory machine-readable storage medium including instructions that, when executed by a machine, cause the machine to perform operations including identifying, by a server having one or more processors, a plurality of jobs for presentation to a first member of a social network, a profile of the first member including professional information about the first member, each job being associated with a respective company, each job having a job affinity score based on a comparison of data of the job and the profile of the first member; for each company, identifying a virtual team of members from the social network working on the company, the virtual team members being identified based on a similarity coefficient between the professional information of the first member and the professional information of the virtual team member; determining a virtual team score based on a professional score for each virtual team member, the professional score being based on the professional information of the virtual team member; ranking, by the server, the jobs based on the virtual team score of the company of the job and the job affinity score; and causing, by the server, presentation of a group including one or more of the ranked jobs in a user interface of the first member based on the ranking.

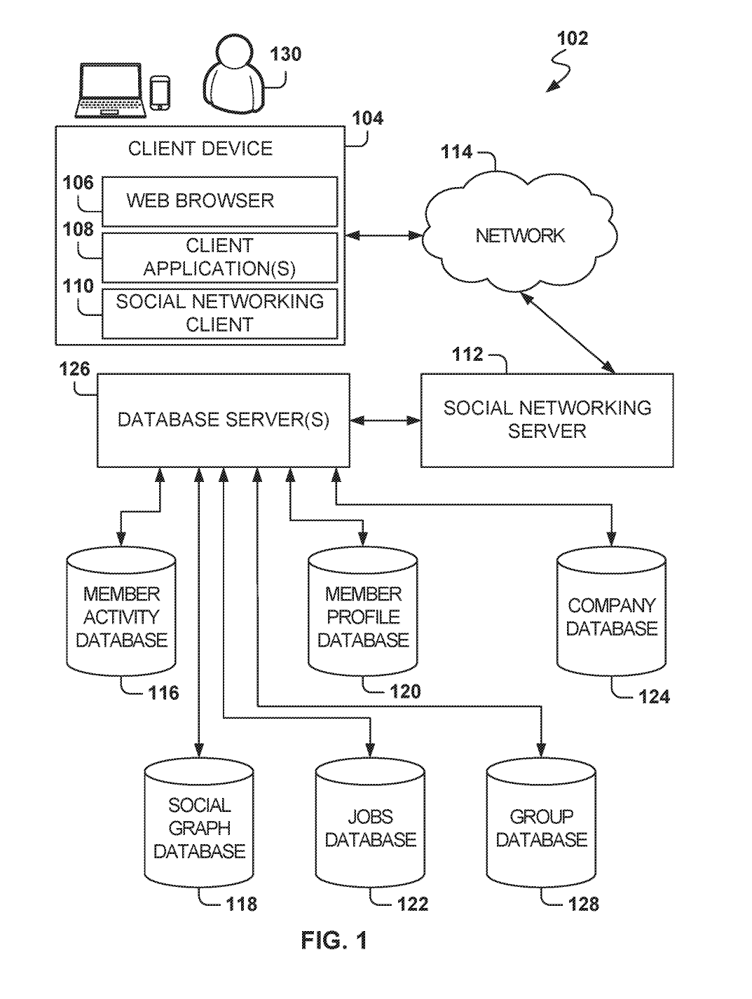

FIG. 1 is a block diagram illustrating a network architecture 102, according to some example embodiments, including a social networking server 112. The social networking server 112 provides server-side functionality via a network 114 (e.g., the Internet or a wide area network (WAN)) to one or more client devices 104. FIG. 1 illustrates, for example, a web browser 106, client application(s) 108, and a social networking client 110 executing on a client device 104. The social networking server 112 is further communicatively coupled with one or more database servers 126 that provide access to one or more databases 116-128.

The client device 104 may comprise, but is not limited to, a mobile phone, a desktop computer, a laptop, a portable digital assistant (PDA), a smart phone, a tablet, a book reader, a netbook, a multi-processor system, a microprocessor-based or programmable consumer electronic system, or any other communication device that a user 130 may utilize to access the social networking server 112. In some embodiments, the client device 104 may comprise a display module (not shown) to display information (e.g., in the form of user interfaces). In further embodiments, the client device 104 may comprise one or more of touch screens, accelerometers, gyroscopes, cameras, microphones, global positioning system (GPS) devices, and so forth.

In one embodiment, the social networking server 112 is a network-based appliance that responds to initialization requests or search queries from the client device 104. One or more users 130 may be a person, a machine, or another means of interacting with the client device 104. In various embodiments, the user 130 is not part of the network architecture 102, but may interact with the network architecture 102 via the client device 104 or another means. For example, one or more portions of the network 114 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network a Wi-Fi® network, a WiMax network, another type of network, or a combination of two or more such networks.

The client device 104 may include one or more applications (also referred to as “apps”) such as, but not limited to, the web browser 106, the social networking client 110, and other client applications 108, such as a messaging application, an electronic mail (email) application, a news application, and the like. In some embodiments, if the social networking client 110 is present in the client device 104, then the social networking client 110 is configured to locally provide the user interface for the application and to communicate with the social networking server 112, on an as-needed basis, for data and/or processing capabilities not locally available (e.g., to access a member profile, to authenticate a user 130, to identify or locate other connected members, etc.). Conversely, if the social networking client 110 is not included in the client device 104, the client device 104 may use the web browser 106 to access the social networking server 112.

Further, while the client-server-based network architecture 102 is described with reference to a client-server architecture, the present subject matter is of course not limited to such an architecture, and could equally well find application in a distributed, or peer-to-peer, architecture system, for example.

In addition to the client device 104, the social networking server 112 communicates with the one or more database server(s) 126 and database(s) 116-128. In one example embodiment, the social networking server 112 is communicatively coupled to a member activity database 116, a social graph database 118, a member profile database 120, a jobs database 122, a group database 128, and a company database 124. Each of the databases 116-128 may be implemented as one or more types of database including, but not limited to, a hierarchical database, a relational database, an object-oriented database, one or more flat files, or combinations thereof.

The member profile database 120 stores member profile information about members who have registered with the social networking server 112. With regard to the member profile database 120, the member may include an individual person or an organization, such as a company, a corporation, a nonprofit organization, an educational institution, or other such organizations.

Consistent with some example embodiments, when a user initially registers to become a member of the social networking service provided by the social networking server 112, the user is prompted to provide some personal information, such as name, age (e.g., birth date), gender, interests, contact information, home town, address, spouse's and/or family members' names, educational background (e.g., schools, majors, matriculation and/or graduation dates, etc.), employment history, professional industry (also referred to herein simply as industry), skills, professional organizations, and so on. This information is stored, for example, in the member profile database 120. Similarly, when a representative of an organization initially registers the organization with the social networking service provided by the social networking server 112, the representative may be prompted to provide certain information about the organization, such as a company industry. This information may be stored, for example, in the member profile database 120. In some embodiments, the profile data may be processed (e.g., in the background or offline) to generate various derived profile data. For example, if a member has provided information about various job titles that the member has held with the same company or different companies, and for how long, this information may be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

In some example embodiments, the company database 124 stores information regarding companies in the member's profile. A company may also be a member, but some companies may not be members of the social network although some of the employees of the company may be members of the social network. The company database 124 includes company information, such as name, industry, contact information, website, address, location, geographic scope, and the like.

As members interact with the social networking service provided by the social networking server 112, the social networking server 112 is configured to monitor these interactions. Examples of interactions include, but are not limited to, commenting on posts entered by other members, viewing member profiles, editing or viewing a member's own profile, sharing content from outside of the social networking service (e.g., an article provided by an entity other than the social networking server 112), updating a current status, posting content for other members to view and comment on, job suggestions for the members, job-post searches, and other such interactions. In one embodiment, records of these interactions are stored in the member activity database 116, which associates interactions made by a member with his or her member profile stored in the member profile database 120. In one example embodiment, the member activity database 116 includes the posts created by the members of the social networking service for presentation on member feeds.

The jobs database 122 includes job postings offered by companies in the company database 124. Each job posting includes job-related information such as any combination of employer, job title, job description, requirements for the job, salary and benefits, geographic location, one or more job skills required, day the job was posted, relocation benefits, and the like.

The group database 128 includes group-related information. As used herein, a group includes jobs that are selected based on a group characteristic that provides an indication of why the jobs in the group are selected for presentation to the member. Examples of group characteristics include relationships between an educational institution of the member and the employees of a company who also attended the educational institution, virtual teams in the company with profiles similar to the member's profile, cultural fit of the member within the company, social connections of the members who work at the company, etc.

Members of the social networking service may establish connections with one or more members of the social networking service. The connections may be defined as a social graph, where the member is represented by a vertex in the social graph and the edges identify connections between vertices. Members are said to be first-degree connections where a single edge connects the vertices representing the members, otherwise, members are said to have connections of the n^{th} degree, where n is defined as the number of edges separating two vertices. In one embodiment, the social graph maintained by the social networking server 112 is stored in the social graph database 118.

In one embodiment, the social networking server 112 communicates with the various databases 116-128 through the one or more database server(s) 126. In this regard, the database server(s) 126 provide one or more interfaces and/or services for providing content to, modifying content in, removing content from, or otherwise interacting with the databases 116-128. For example, and without limitation, such interfaces and/or services may include one or more Application Programming Interfaces (APIs), one or more services provided via a Service-Oriented Architecture (SOA), one or more services provided via a REST-Oriented Architecture (ROA), or combinations thereof. In an alternative embodiment, the social networking server 112 communicates directly with the databases 116-128 and includes a database client, engine, and/or module, for providing data to, modifying data stored within, and/or retrieving data from the one or more databases 116-128.

While the database server(s) 126 are illustrated as a single block, one of ordinary skill in the art will recognize that the database server(s) 126 may include one or more such servers. For example, the database server(s) 126 may include, but are not limited to, a Microsoft® Exchange Server, a Microsoft® Sharepoint® Server, a Lightweight Directory Access Protocol (LDAP) server, a MySQL database server, or any other server configured to provide access to one or more of the databases 116-128, or combinations thereof. Accordingly, and in one embodiment, the database server(s) 126 implemented by the social networking service are further configured to communicate with the social networking server 112.

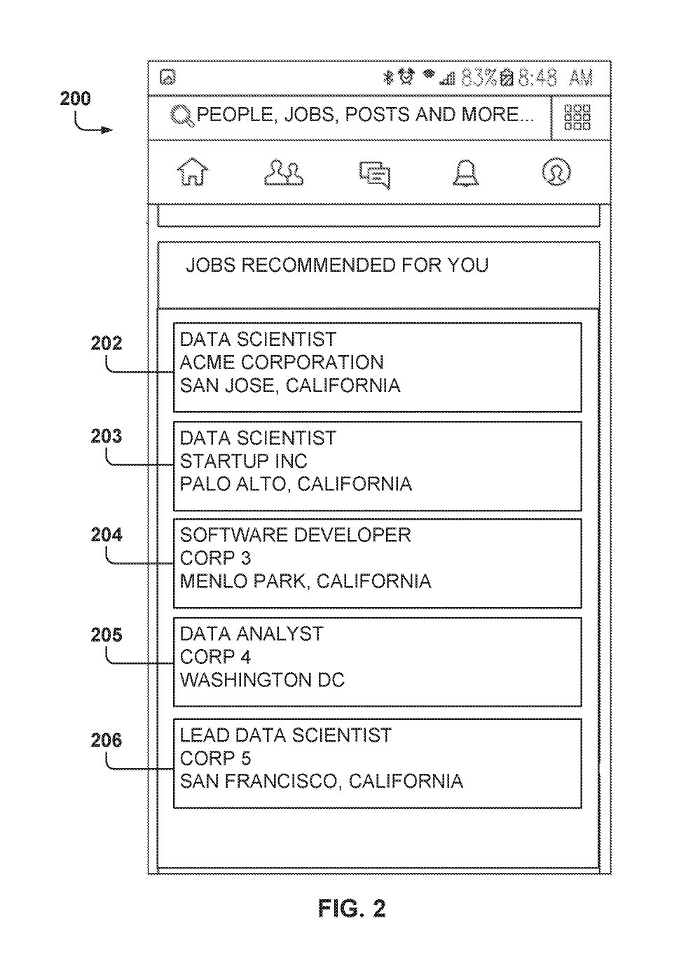

FIG. 2 is a screenshot of a user interface 200 that includes recommendations for jobs 202-206, according to some example embodiments. In one example embodiment, the social network user interface provides job recommendations, which are job postings that match the job interests of the user and that are presented without a specific job search request from the user (e.g., job suggestions).

In another example embodiment, a job search interface is provided for entering job searches, and the resulting job matches are presented to the user in the user interface 200. As the user scrolls down the user interface 200, more job recommendations are presented to the user. In some example embodiments, the job recommendations are prioritized to present jobs in an estimated order of interest to the user.

The user interface 200 presents a “flat” list of job recommendations as a single list. Other embodiments presented below utilize a “segmented” list of job recommendations where each segment is a group that is associated with a related reason indicating why these jobs are being recommended within the group.

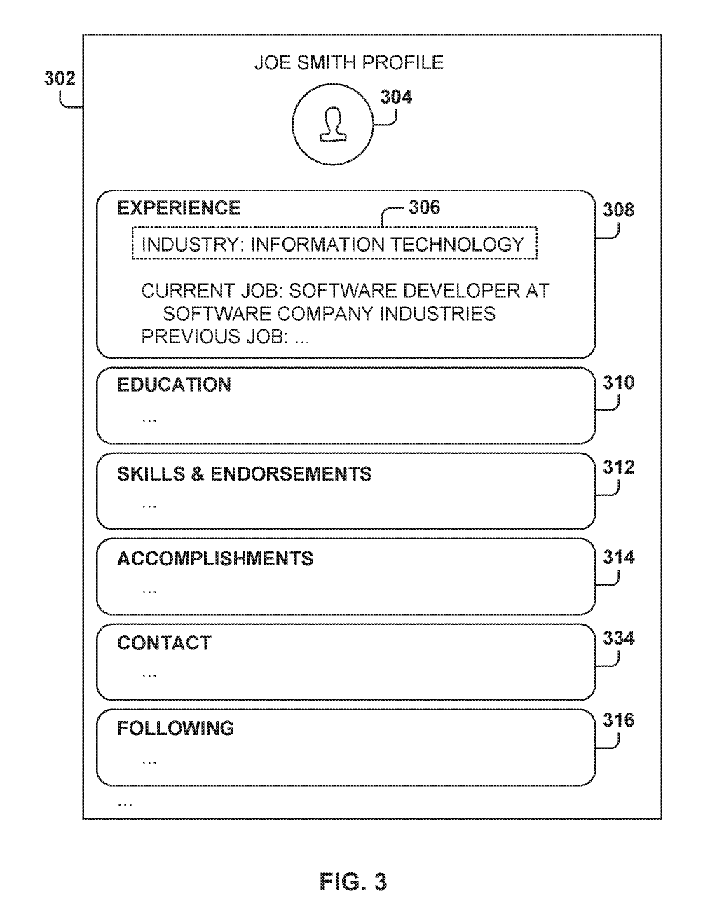

FIG. 3 is a screenshot of a user's profile view, according to some example embodiments. Each user in the social network has a member profile 302, which includes information about the user. The member profile 302 is configurable by the user and also includes information based on the user's activity in the social network (e.g., likes, posts read).

In one example embodiment, the member profile 302 may include information in several categories, such as a profile picture 304, experience 308, education 310, skills and endorsements 312, accomplishments 314, contact information 334, following 316, and the like. Skills include professional competencies that the member has, and the skills may be added by the member or by other members of the social network. Example skills include C++, Java. Object Programming, Data Mining. Machine Learning. Data Scientist, and the like. Other members of the social network may endorse one or more of the skills and, in some example embodiments, the member's account is associated with the number of endorsements received for each skill from other members.

The experience 308 information includes information related to the professional experience of the user. In one example embodiment, the experience 308 information includes an industry 306, which identifies the industry in which the user works. In one example embodiment, the user is given an option to select an industry from a plurality of industries when entering this value in the member profile 302. The experience 308 information area may also include information about the current job and previous jobs held by the user.

The education 310 information includes information about the educational background of the user, including the educational institutions attended by the user, the degrees obtained, and the field of study of the degrees. For example, a member may list that the member attended the University of Michigan and obtained a graduate degree in computer science. For simplicity of description, the embodiments presented herein are presented with reference to universities as the educational institutions, but the same principles may be applied to other types of educational institutions, such as high schools, trade schools, professional training schools, etc.

The skills and endorsements 312 information includes information about professional skills that the user has identified as having been acquired by the user, and endorsements entered by other users of the social network supporting the skills of the user. The accomplishments 314 area includes accomplishments entered by the user, and the contact information 334 includes contact information for the user, such as an email address and phone number. The following 316 area includes the names of entities in the social network being followed by the user.

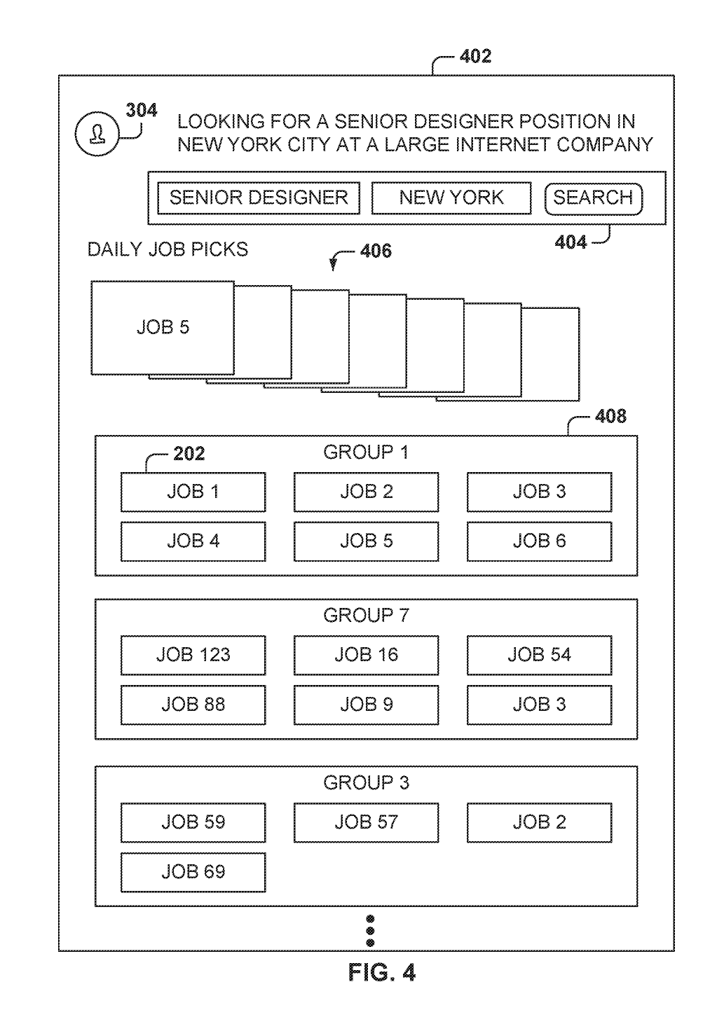

FIG. 4 is a diagram of a user interface 402, according to some example embodiments, for presenting job postings to a member of the social network. The user interface 402 includes the profile picture 304 of the member, a search section 404, a daily jobs section 406, and one or more group areas 408. In some example embodiments, a message next to the profile picture 304 indicates the goal of the search. e.g., “Looking for a senior designer position in New York City at a large Internet company.”

The search section 404, in some example embodiments, includes two boxes for entering search parameters: a keyword input box for entering any type of keywords for the search (e.g., job title, company name, job description, skill, etc.), and a geographic area input box for entering a geographic area for the search (e.g., New York). This allows members to execute searches based on keyword and location. In some embodiments, the geographic area input box includes one or more of city, state, ZIP code, or any combination thereof.

In some example embodiments, the search boxes may be prefilled with the user's title and location if no search has been entered yet. Clicking the search button causes the search of jobs based on the keyword inputs and location. It is to be noted that the inputs are optional, and one search input may be entered at a time, or both search boxes maybe filled in.

The daily jobs section 406 includes information about one or more jobs selected for the user, based on one or more parameters, such as member profile data, search history, job match to the member, recentness of the job, whether the user is following the job, etc.

Each group area 408 includes one or more jobs 202 for presentation in the user interface 402. In one example embodiment, the group area 408 includes one to six jobs 202 with an option to scroll the group area 408 to present additional jobs, if available.

Each group area 408 provides an indication of why the member is being presented with those jobs 202, which identifies the characteristic of the group. There could be several types of reasons related to the connection of the user to the job, the affinity of the member to the group, the desirability of the job, or the time deadline of the job (e.g., urgency). The reasons related to the connection of the user to the job may include relationships between the job and the social connections of the member (e.g., “Your connections can refer you to this set of jobs”), a quality of a fit between the job and the user characteristics (e.g., “This is a job from a company that hires from our school”), a quality of a match between the member's talent and the job (e.g., “You would be in the top 90% of all applicants), etc.

Further, the group characteristics may be implicit (e.g., “These jobs are recommended based on your browsing history”) or explicit (e.g., “These are jobs from companies you followed”). The desirability reasons may include popularity of the job in the member's area (e.g., most-viewed by other members or most applications received), jobs from in-demand start-ups in the member's area, and popularity of the job among people with the same title as the member. Further yet, the time-urgency reasons may include “Be the first to apply to these jobs.” or “These jobs will be expiring soon.”

It is to be noted that the embodiments illustrated in FIG. 4 are examples and do not describe every possible embodiment. Other embodiments may utilize different layouts or groups, present fewer or more jobs, present fewer or more groups, etc. The embodiments illustrated in FIG. 4 should therefore not be interpreted to be exclusive or limiting, but rather illustrative.

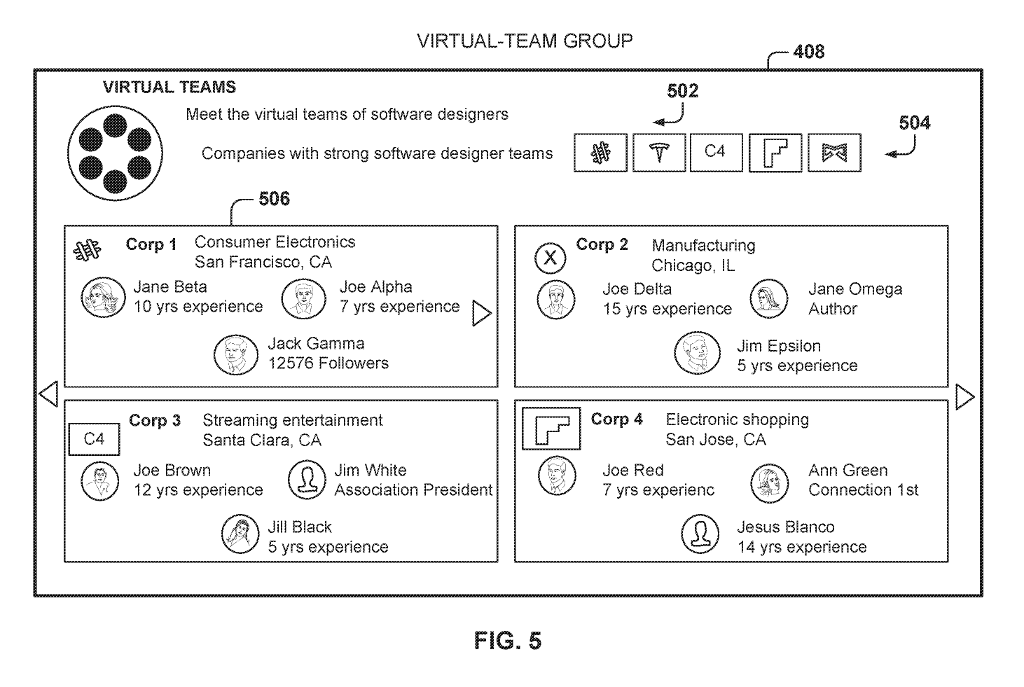

FIG. 5 is a detail of the group area 408 in the user interface 402, according to some example embodiments. In one example embodiment, the group area 408 is for a group referred to as a “virtual-teams group” and presents jobs in companies that have strong virtual teams. The goal is to find the virtual team for a specific job and the specific member. For example, if the member is a software designer, then a virtual team is created including people that are software designers working in the same company and in the same location. There could be different teams in different locations, so the location may be used to separate the virtual teams, although in some other embodiments, the location is not considered for creating the virtual team.

If only the job and the location were considered for creating the virtual team, without considering the member's professional skills, then the virtual teams may be not as relevant to the member. For example, software designers within a company may be working for very different projects; thus, in order to find people that work in the projects that the member is interested in, considering the skills of the member and the potential virtual team members is beneficial.

Further, estimating the quality of the potential team for the member is beneficial because, in many cases, the job satisfaction of an employee is closely linked to the fit of the employee within the team and how the employee interacts with other team members at work.

In one example embodiment, the virtual-team group area 408 includes a group description area describing the name of the group (e.g., Virtual Teams), and an introductory message 502 (e.g., “Meet the virtual teams of software designers”). In addition, some logos or profile pictures for the companies included in this group are presented in icon area 504.

Each job 506 includes information about the job 506 and information about the virtual team. Information about the company posting the job 506 is presented, such as the logo of the company, industry, and location for the job 506. The virtual team description includes a plurality of virtual team members with a respective profile picture, name, and professional information (e.g., 10 years experience. 12576 followers). If a profile picture is not available for a user, a “ghost” picture may be displayed, where a ghost picture is a generic icon for a user without a profile picture.

In some example embodiments, the job description may also be included (not shown), such as the job title, job location, and job statistics (e.g., the number of days since the job was first posted, the number of members who have viewed the job, and the number of applications for the job received in the social network). In addition, any combination of profile pictures, member names, and member titles may be included to identify the connections of the member to the job via the member's connections in the social network.

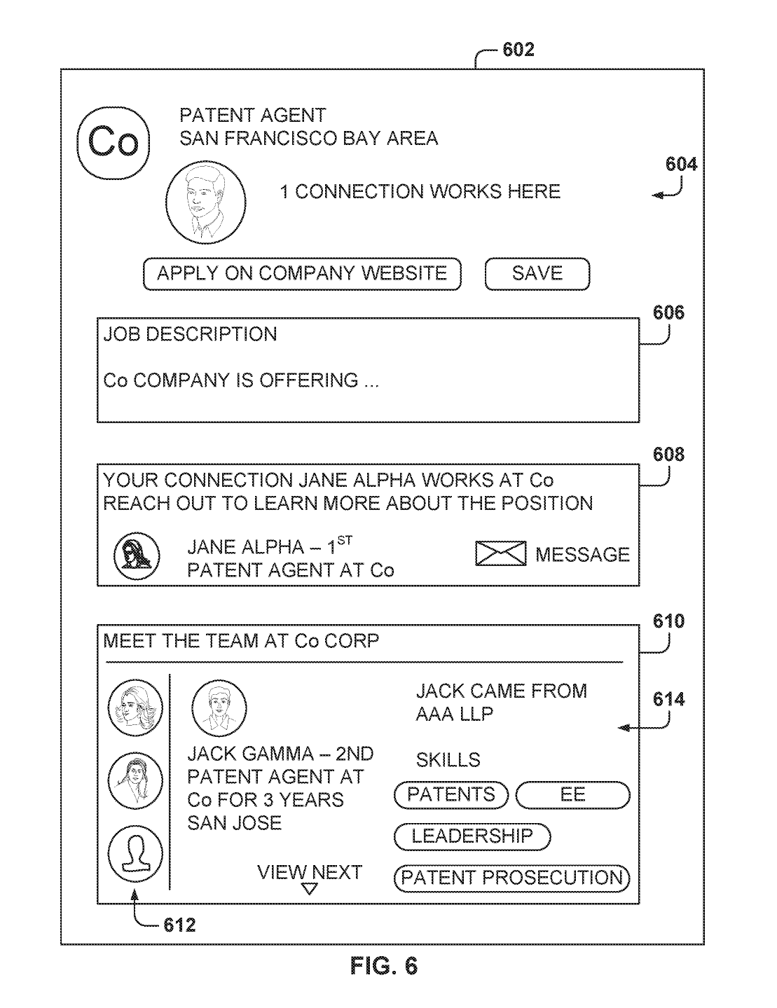

FIG. 6 is a diagram of a user interface 602, according to some example embodiments, for presenting a virtual team associated with a job posting. The user interface 602 is for presenting a job page to the member. The job page includes information about the job, such as the name of the company and connections that work at the company 604, buttons for applying to the job in the company website or for saving the job into the member's list of interesting jobs, a job description 606, a connections area 608, and a virtual team area 610. The connections area 608 presents one or more members of the social network that work at the company that posted the job and that are socially connected to the member in the social network (directly or indirectly).

The virtual team area 610 includes a header (e.g., “Meet the team at Co Corp”), and information about the members of the virtual team. For example, one of the virtual team members is highlighted, and the information 614 of this member is presented in more detail, including the profile picture, name, professional experience, and skills. A scrolling option is available (e.g., View next) to select the next member of the virtual team.

On the left, profile pictures 612 for other team members are presented, and if the member clicks on one of the profile pictures 612, the detailed information for the selected team member is presented. Thus, the user interface 602 shows people that may work with the member if the member joined the company. One of the reasons for choosing a job is that a person may want to work in a good team. These are possibly the people that the member will interact with on a day-to-day basis.

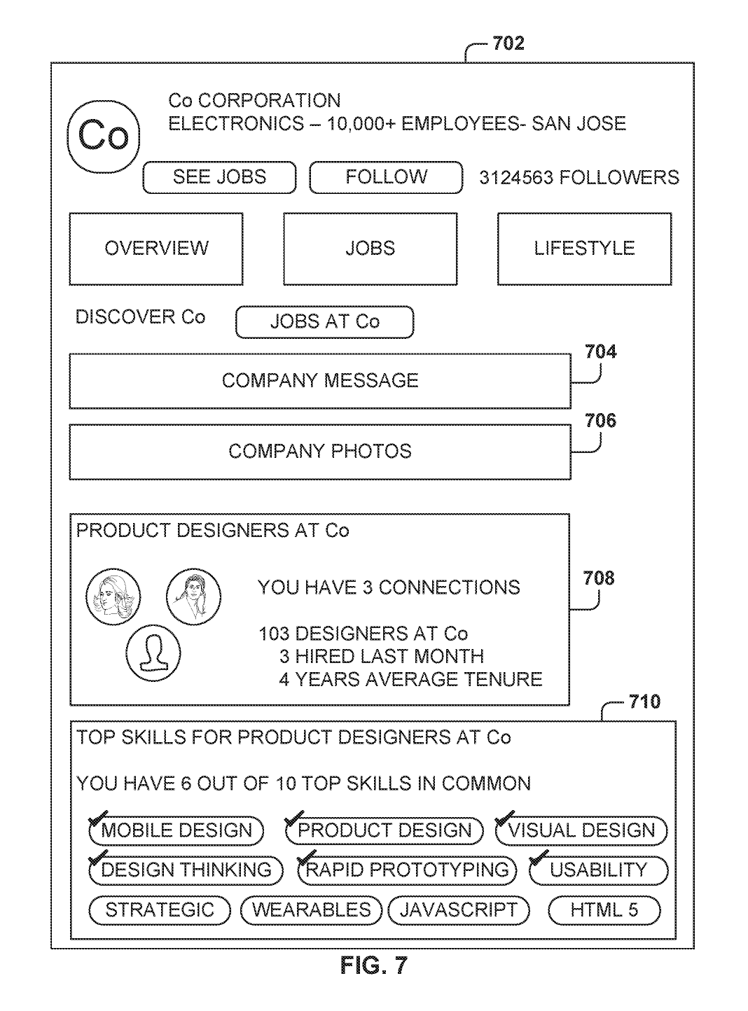

FIG. 7 is a diagram of a user interface, according to some example embodiments, for presenting a virtual team within a company page. The user interface shows a company page 702 with information about a company. The member may reach the company page 702 during a search for the company information or when inquiring about a job offered by the company.

The company page 702 includes company information, such as company name, company logo, overview, jobs, lifestyle, company message 704, company photos 706, virtual team 708, and team skills 710. Some buttons are presented, such as a button to find jobs in the company or to follow the company in the social network.

The virtual team 708 includes information about the virtual team, such as profile pictures, names, professional information, number of connections in the virtual team 708, statistics about employees with the same title as the member (e.g., 103 designers at Co. three hired last month).

The team skills 710 provides information about the skills of the virtual team members and how they relate to the skills of the job seeker. For example, the team skills 710 identifies the top skills for product designers at the company, and indicates that the member has six out of ten of the top skills in common with the virtual team. In some example embodiments, the top skills are listed, and a checkmark is placed on the skills that are shared with the virtual team members, but other interfaces for presenting the skills are also possible.

It is noted that the embodiments illustrated in FIGS. 6 and 7 are examples and do not describe every possible embodiment. Other embodiments may utilize different layouts, additional or less information, etc. The embodiments illustrated in FIGS. 6 and 7 should therefore not be interpreted to be exclusive or limiting, but rather illustrative.

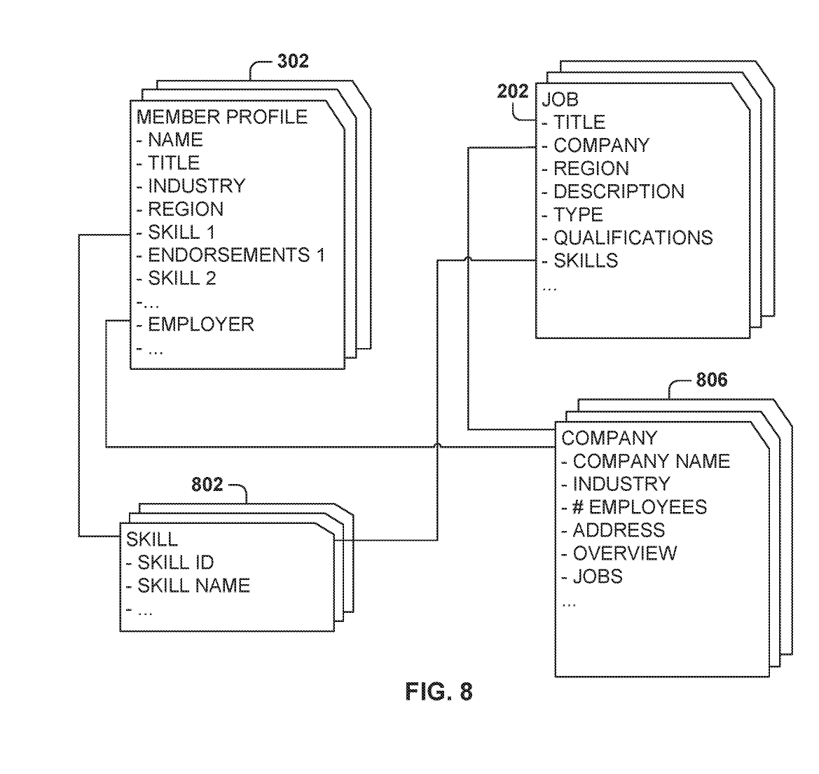

FIG. 8 illustrates data structures for storing job and member information, according to some example embodiments. The member profile 302, as discussed above, includes member information, such as name, title (e.g., job title), industry (e.g., legal services), geographic region, employer, skills and endorsements, and so forth. In some example embodiments, the member profile 302 also includes job-related data, such as jobs previously applied to, or jobs already suggested to the member (and how many times each job has been suggested to the member). Within the member profile 302, the skill information is linked to skill data 802, and the employer information is linked to company data 806.

In one example embodiment, the company data 806 includes company information, such as company name, industry associated with the company, number of employees at the company, address of the company, overview description of the company, job postings associated with the company, and the like

The skill data 802 is a table for storing the different skills identified in the social network. In one example embodiment, the skill data 802 includes a skill identifier (ID) (e.g., a numerical value or a text string) and a name for the skill. The skill identifier may be linked to the member profile 302 and job 202 data.

In one example embodiment, the job 202 data includes data for jobs posted by companies in the social network. The job 202 data includes one or more of a title associated with the job (e.g., Software Developer), a company that posted the job, a geographic region where the job is located, a description of the job, a type of the job, qualifications required for the job, and one or more skills. The job 202 data may be linked to the company data 806 and the skill data 802.

It is to be noted that the embodiments illustrated in FIG. 8 are examples and do not describe every possible embodiment. Other embodiments may utilize different data structures or fewer data structures, combine the information from two data structures into one, have additional or fewer links among the data structures, and the like. The embodiments illustrated in FIG. 8 should therefore not be interpreted to be exclusive or limiting, but rather illustrative.

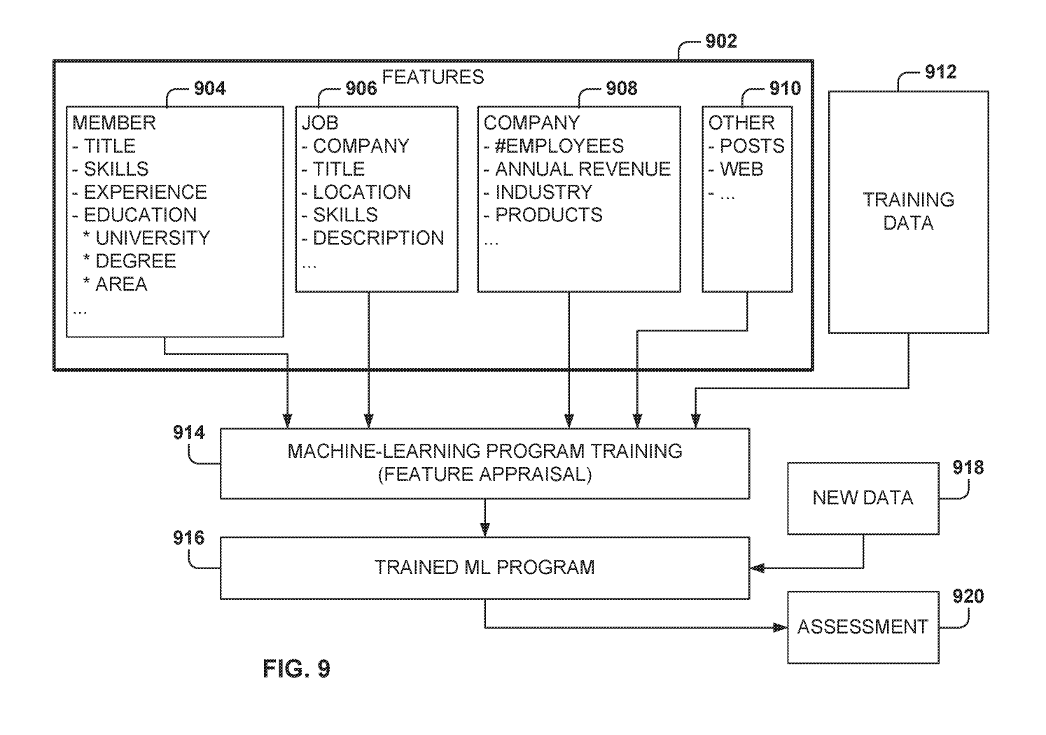

FIG. 9 illustrates the training and use of a machine-learning program 916 according to some example embodiments. In some example embodiments, machine-learning programs, also referred to as machine-learning algorithms or tools, are utilized to perform operations associated with job searches.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 912 in order to make data-driven predictions or decisions expressed as outputs or assessments 920. Although example embodiments are presented with respect to a few machine-learning tools, the principles presented herein may be applied to other machine-learning tools.

In some example embodiments, different machine-learning tools may be used. For example, Logistic Regression (LR), Naive-Bayes. Random Forest (RF), neural networks (NN), matrix factorization, and Support Vector Machines (SVM) tools may be used for classifying or scoring job postings.

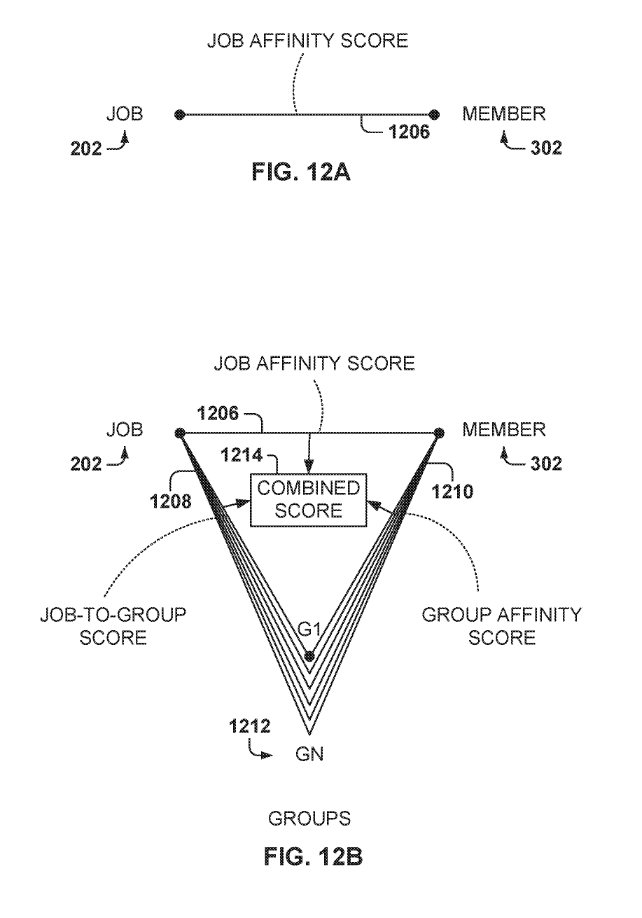

In general, there are two types of problem in machine learning: classification problems and regression problems. Classification problems aim at classifying items into one of several categories (for example, is this object an apple or an orange?). Regression algorithms aim at quantifying some items (for example, by providing a value that is a real number). In some embodiments, example machine-learning algorithms provide a job affinity score (described in more detail below with reference to FIG. 12A) (e.g., a number from 1 to 100) to qualify each job as a match for the user (e.g., calculating the job affinity score). In other example embodiments, machine learning is also utilized to calculate a group affinity score and a job-to-group score, as discussed in more detail below with reference to FIG. 12B. The machine-learning algorithms utilize the training data 912 to find correlations among identified features 902 that affect the outcome. In yet other embodiments, machine-learning algorithms are utilized for determining similarities between skills of members, or between the professional attributes between members (which include skills, title, industry, and other professional information).

In one example embodiment, the features 902 may be of different types and may include one or more of member features 904, job features 906, company features 908, and other features 910. The member features 904 may include one or more of the data in the member profile 302, as described in FIG. 8, such as title, skills, experience, education, etc. The job features 906 may include any data related to the job, and the company features 908 may include any data related to the company. In some example embodiments, additional features in the other features 910 may be included, such as post data, message data, web data, etc.

With the training data 912 and the identified features 902, the machine-learning tool is trained at operation 914. The machine-learning tool appraises the value of the features 902 as they correlate to the training data 912. The result of the training is the trained machine-learning program 916.

When the trained machine-learning program 916 is used to perform an assessment, new data 918 is provided as an input to the trained machine-learning program 916, and the machine-learning program 916 generates the assessment 920 as output. For example, when a member performs a job search, a machine-learning program, trained with social network data, uses the member data and job data from the jobs in the database to search for jobs that match the member's profile and activity.

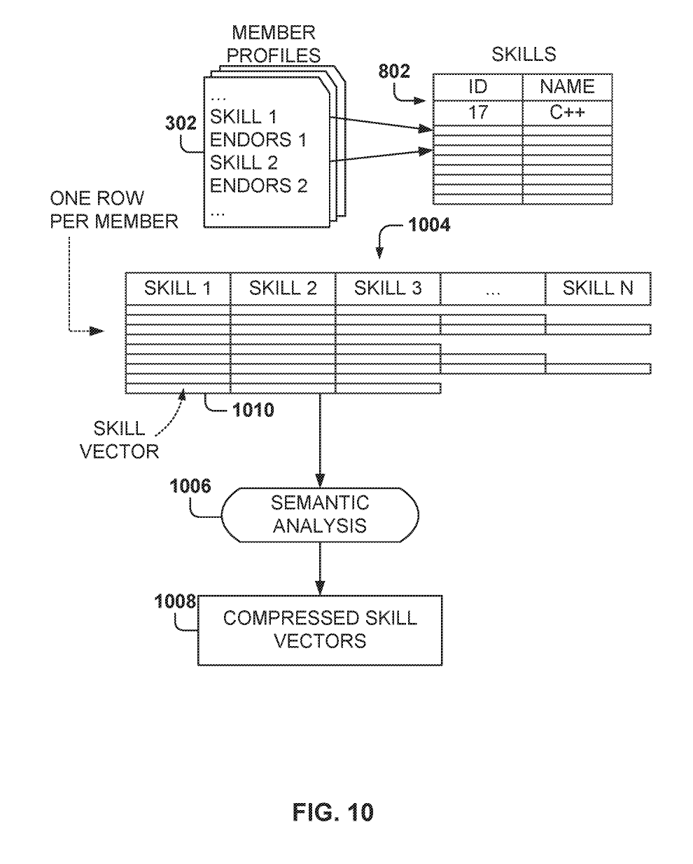

FIG. 10 illustrates a method for identifying similarities among member skills, according to some example embodiments. In some example embodiments, the skills of the members of the social network are represented within a vector in a small dimensional space (e.g., with a dimension of 200). The vectors of the employees of the company are compared to the vector of the member searching for the job, and the employees that have similar vectors are identified as members of the virtual team.

Some example embodiments are presented for comparing member skills, but the same principles may be applied by comparing other features in addition to the skills, such as title, position, function within the company, years of experience, etc., or any combination thereof. In some example embodiments, semantic vectors are created for the skills of members, and in other embodiments, the semantic vectors include the skills, the title, and the job function, for example.

Reducing vector dimension from a sparse vector representation to a compressed vector representation may be done in several ways. In one embodiment, the skills and title of each member are placed within a row, and then matrix factorization is utilized to reduce the vectors to a smaller dimension, such as 50 or 100. Then, on the reduced-dimension pace, a nearest neighbor computation from the member is performed, restricted to the employees of the company of interest, resulting in a similarity coefficient for each employee. This way, the members with similar skills are found. Afterwards, the top members with the best similarity coefficients are selected for the virtual team. For example, the mutual team may include the top four members, or the top six members, or the top 50 members, etc.

In some example embodiments, a similarity threshold is defined, and people are selected for the virtual team when their similarity coefficient with reference to the member is above the similarity threshold. Therefore, there could be the case where there is no virtual team for the member in the company posting the job.

As used herein, the similarity coefficient between a first skill vector and a second skill vector is a real number that quantifies a similarity between the skills of the first member and the skills of the second member. The similarity coefficient is also referred to herein as the similarity value. In some example embodiments, the similarity coefficient is in the range 0 to 1, but other ranges are also possible. In some embodiments, cosine similarity is utilized to calculate the similarity coefficient between the skill vectors.

In some example embodiments, the skill data 802 includes a skill identifier (e.g., an integer value) and a skill description text (e.g., C++). The member profiles 302 are linked to the skill identifier, in some example embodiments.

Semantic analysis finds similarities among member skills by creating a vector for each member such that members with similar skills have skill vectors 1008 near each other. In one example embodiment, the tool Word2vec is used to perform the semantic analysis, but other tools may also be used, such as Gensim. Latent Dirichlet Allocation (LDA), or Tensor flow.

These models are shallow, two-layer neural networks that are trained to reconstruct linguistic contexts of words. Word2vec takes as input a large corpus of text and produces a high-dimensional space (typically between a hundred and several hundred dimensions). Each unique word in the corpus is assigned a corresponding vector in the space. The vectors are positioned in the vector space such that words that share common contexts in the corpus are located in close proximity to one another in the space. In one example embodiment, each element of the skill vector 1008 is a real number.

Initially, a simple skill vector 1010 is created for each skill, where each simple skill vector 1010 includes a plurality of zeros and a 1 at the location corresponding to the skill. Afterwards, a concatenated skill table 1004 is created, where each row includes a sequence with all the skills for a corresponding member. Thus, the first row of concatenated skill table 1004 includes all the simple skill vectors 1010 for the skills of the first member, the second row includes all the simple skill vectors 1010 for the skills of the second member, and so forth.

A semantic analysis operation 1006 is then performed on the concatenated skill table 1004. In one example embodiment, Word2vec is utilized, and the result is compressed skill vectors 1008, or simply referred to as “skill vectors,” such that members with similar skills have skill vectors 1008 near each other (e.g., with a similarity coefficient below a predetermined threshold).

Some example results for “machine learning” (with the skill identifier in parenthesis) include the following:
pattern recognition (5449), 0.9100;
neural network (4892), 0.9053;
artificial intelligence (2407), 0.8989;
natural language processing (5835), 0.8836;
algorithm (1070), 0.8834;
algorithm design (6001), 0.8791;
computer vision (4262), 0.8779;
latex (6420), 0.8500;
computer science (1541), 0.8441;
deep learning (50518), 0.8411;
data mining (2682), 0.8356;
texting mining (7198), 0.8326;
parallel computing (5626), 0.8308;
recommender system (12226), 0.8306;
artificial neural network (12469), 0.8252;
data science (50061), 0.8213;
genetic algorithm (7630), 0.8093;
python (1346), 0.8037; and
image processing (2741), 0.8019.

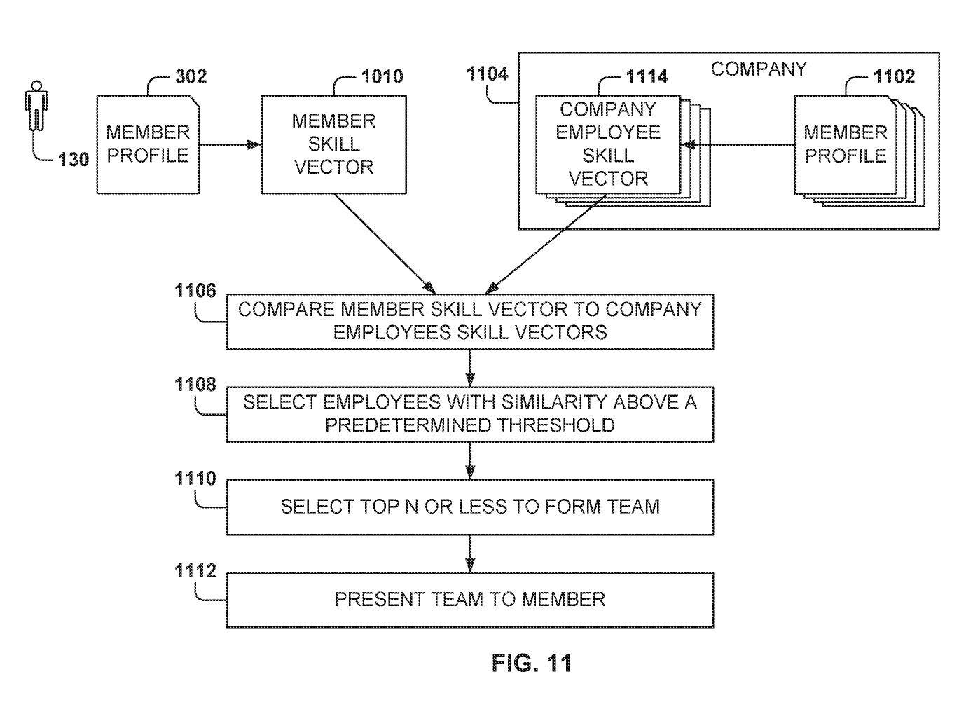

FIG. 11 illustrates a method for presenting a virtual team, according to some example embodiments. As discussed above with reference to FIG. 10, the compressed skill vector 1008 for the member is calculated at operation 1006 based on the member profile 302.

The compressed skill vectors 1114 for the employees of the company 1104 are calculated based on their respective member profile 1102. It is noted that the member profile 1102 may include the demographic and professional information about the user, but may also include the activities performed by the member on the social network or in other networks (e.g., news websites).

In some example embodiments, geographic location is also used to filter the potential virtual team members, such that the virtual team member may be defined for a specific geographic location, which will match the geographic location for the job. Geographic location may be considered if similar teams are found in different locations, such as one team in Europe and another team in the United States. The member may be interested in finding out about the virtual team at the location where the job is offered.

At operation 1106, the compressed member skill vector 1010 is compared to the company employee compressed skill vectors 1114. For example, in one embodiment, the compressed skill vectors 1010 and 1114 are compared utilizing cosine similarity. In other embodiments, other similarity algorithms may be used to calculate the similarity coefficient.

At operation 1108, the employees with a similarity coefficient above a predetermined threshold are selected as candidates for the virtual team. In some example embodiments, the virtual team members are ranked according to the similarity coefficient.

From operation 1108, the method flows to operation 1110, where the top n virtual team members are selected based on their similarity coefficient. The n value may be in the range from two to fifty, although other values are also possible. In one example embodiment, if the member is looking at a job in his own company, the member may be eliminated from the virtual team since the similarity coefficient would be a perfect 100%. For example, this may be useful in case the member is looking for a different job within the same company. At operation 1112, the team is presented to the member, such as at the user interfaces described above with reference to FIGS. 4 to 7.

FIGS. 12A-12B illustrate the scoring of a job for a member, according to some example embodiments. FIG. 12A illustrates the scoring, also referred to herein as ranking, of a job 202 for a member associated with a member profile 302 based on a job affinity score 1206.

The job affinity score 1206, between a job and a member, is a value that measures how well the job matches the interest of the member in finding the job. A so-called “dream job” for a member would be the perfect job for the member and would have a high, or even maximum, value, while a job that the member is not interested in at all (e.g., in a different professional industry) would have a low job affinity score 1206. In some example embodiments, the job affinity score 1206 is a value between zero and one, or a value between zero and 100, although other ranges are possible.

In some example embodiments, a machine-learning program is used to calculate the job affinity scores for the jobs available to the member. The machine-learning program is trained with existing data in the social network, and the machine-learning program is then used to evaluate jobs based on the features used by the machine-learning program. In some example embodiments, the features include any combination of job data (e.g., job title, job description, company, geographic location, etc.), member profile data, member search history, employment of social connections of the member, job popularity in the social network, number of days the job has been posted, company reputation, company size, company age, profit vs. nonprofit company, and pay scale.

FIG. 12B illustrates the scoring of a job 202 for a member associated with the member profile 302, according to some example embodiments, based on three parameters: the job affinity score 1206, a job-to-group score 1208, and a group affinity score 1210. Broadly speaking, the job affinity score 1206 indicates how relevant the job 202 is to the member, the job-to-group score 1208 indicates how relevant the job 202 is to a group 1212, and the group affinity score 1210 indicates how relevant the group 1212 is to the member.

The group affinity score 1210 indicates how relevant the group 1212 is to the member, where a high affinity score indicates that the group 1212 is very relevant to the member and should be presented in the user interface, while a low affinity score indicates that the group 1212 is not relevant to the member and may be omitted from presentation in the user interface.

The group affinity score 1210 is used, in some example embodiments, to determine which groups 1212 are presented in the user interface, and the group affinity score 1210 is also used to order the groups 1212 when presenting them in the user interface, such that the groups 1212 may be presented in the order of their respective group affinity scores 1210. It is to be noted that if there is not enough “liquidity” of jobs for a group 1212 (e.g., there are not enough jobs for presentation in the group 1212), the group 1212 may be omitted from the user interface or presented with lower priority, even if the group affinity score 1210 is high.

In some example embodiments, a machine-learning program is utilized for calculating the group affinity score 1210. The machine-learning program is trained with member data, including interactions of users with the different groups 1212. The data for the particular member is then utilized by the machine-learning program to determine the group affinity score 1210 for the member with respect to a particular group 1212. The features utilized by the machine-learning program include the history of interaction of the member with jobs from the group 1212, click data for the member (e.g., a click rate based on how many times the member has interacted with the group 1212), member interactions with other members who have a relationship to the group 1212, etc. For example, one feature may include an attribute that indicates whether the member is a student; if the member is a student, features such as social connections or education-related attributes will be relevant to which groups are of interest to the student, while a member who has been out of school for 20 years or more may not be as interested in education-related features.

Another feature of interest to determine group participation is whether the member has worked in small companies or large companies throughout a long career. If the member exhibits a pattern of working for large companies, a group that provides jobs for large companies would likely be of more interest to the member than a group that provides jobs in small companies, unless there are other factors, such as recent interaction of the member with jobs from small companies.

The job-to-group score 1208 between a job 202 and a group 1212 indicates the job 202's strength within the context of the group 1212, where a high job-to-group score 1208 indicates that the job 202 is a good candidate for presentation within the group 1212 and a low job-to-group score 1208 indicates that the job 202 is not a good candidate for presentation within the group 1212. In some example embodiments, a predetermined threshold is identified, wherein jobs 202 with a job-to-group score 1208 equal to or above the predetermined threshold are included in the group 1212 and jobs 202 with a job-to-group score 1208 below the predetermined threshold are not included in the group 1212.

For example, in a group 1212 that presents jobs within the social network of the member, if there is a job 202 for a company within the network of the member, the job-to-group score 1208 indicates how strong the member's network is for reaching the company of the job 202.

In some example embodiments, the job affinity score 1206, the job-to-group score 1208, and the group affinity score 1210 are combined to obtain a combined score 1214 for the job 202. The scores may be combined utilizing addition, weighted averaging, or other mathematical operations.

FIG. 12B illustrates that, for a given job 202 and member profile 302, there may be a plurality of groups 1212 G1, . . . . GN. Embodiments presented herein identify which jobs fit better in which group, and which groups have higher priority for presentation to the member.

In the virtual-team group, the job-to-group score 1208 measures the strength of the virtual team for the company associated with the job. In the virtual-team ranking phase, a score is assigned to each virtual team member based on their professional accomplishments, such as education, companies worked at, years of experience, number of followers, number of presentations at major conferences, number of published papers, number of issued patents, number of skill endorsements, etc. Thus, the professional strength for each member of the team is calculated and then an aggregated value is calculated for the virtual team.

As discussed above, geographic location may also be entered into the search, such that the member may ask. “What is the best machine-learning team in Silicon Valley?”

In other embodiments, additional criteria may be included in the ranking of the virtual teams. For example, if the member wants to work for small teams, the team size may be used to rank the virtual teams.

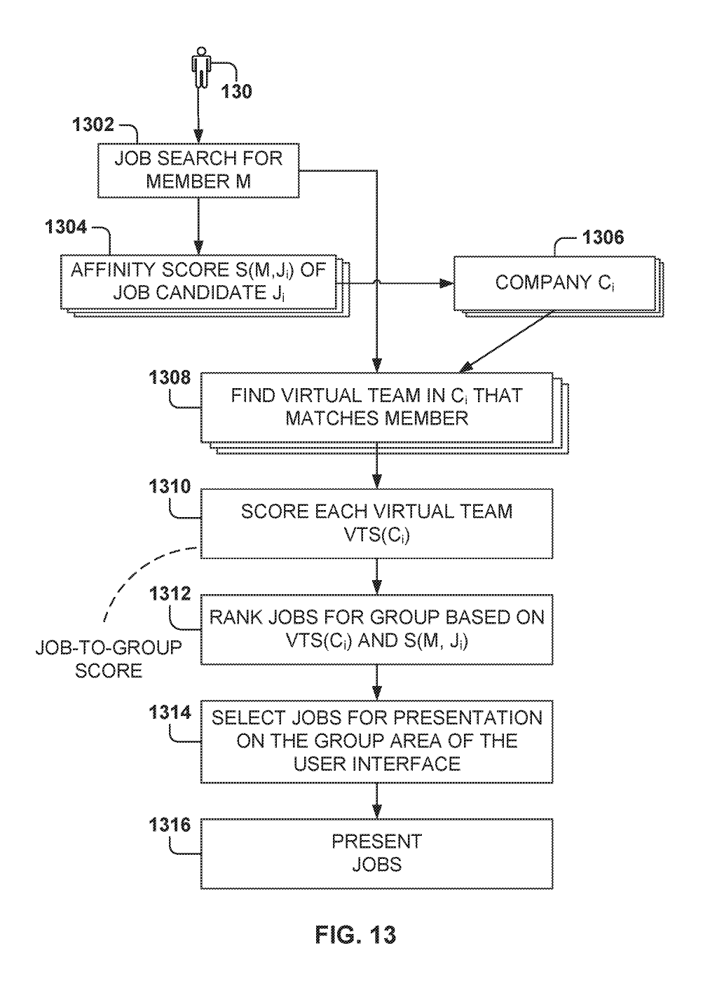

FIG. 13 illustrates a method for selecting jobs for presentation within the group, according to some example embodiments. At operation 1302, a job search is performed for member M 130. The job search may be originated by the member, or may be originated by the social network in order to propose job postings to the member. The result 1304 is a plurality of job candidates Jᵢ for presentation to the member based on their affinity scores S(M, Jᵢ). In some embodiments, the candidate jobs Jᵢ may be filtered. In one example embodiment, the candidate jobs having affinity scores S(M, Jᵢ) higher or equal to a predetermined threshold are considered for presentation, while candidate jobs having affinity scores S(M, Jᵢ) lower than the predetermined threshold are omitted from consideration for presentation to the member.

Each job candidate Jᵢ is associated with a respective company Cᵢ 1306, and in operation 1308 the virtual team is found, if there are members available to form the team, for each company Cᵢ 1306, where the virtual team members have similar skills as the member, as discussed above with reference to FIG. 11.

The job-to-group score 1208 for the virtual team group is called the virtual-team score VTS. The virtual-team score VTS(Cᵢ) for company Cᵢ is calculated based on a professional score PS for each of the virtual team members, also referred to as a skill metric. The virtual-team score VTS(Cᵢ) is calculated for each job Jᵢ by combining the PSⱼ for all the virtual-team members Mⱼ. The combination may be performed by multiplying the scores, by adding the scores, using the maximum, by performing a weighted multiplication, by performing a weighted addition, or by calculating the geometric mean, the average, etc.

In some embodiments, the members with a high PS are given higher weights than other members because the members with the high PS are usually leaders that greatly increase the value of the team (e.g., a software developer with 20 years of experience and that is a Chief Technical Officer). Thus, in some example embodiments, the VTS is calculated as a weighted average of the professional scores PSⱼ of the virtual team members, wherein virtual team members with higher professional scores have higher weights than virtual team members with lower professional scores.

The PS is calculated based on the professional accomplishments of the member, which may include consideration of any of a plurality of factors that include number of years of experience, number of published papers, number of patents obtained, number of companies founded, number of followers in a social network, articles published about the member, and a score for the company where the virtual team member works. For example, if the virtual team includes team members that have started companies, the team will be considered highly entrepreneurial and will be given a high score when searching the startup jobs.

In other example embodiments, the virtual-team score may also be based on the evolution of the company over time. For example, if the company has experienced high growth in the last two years, the score for the virtual team will be increased. Another factor that may be used for scoring the virtual team is a calculation of the value of the company (e.g., measured by the value of the issue stock divided by the number of employees).

In some example embodiments, a limited number of members are selected for calculating the virtual team score in operation 1310. For example, the top 10 virtual team members are selected according to their professional score for calculating the virtual team score. If the team has fewer than 10 members, then the virtual team score is adjusted accordingly based on the number of available members. In other embodiments, a different number of members may be selected, such as in the range from 3 to 20, or some other value.

At operation 1312, the candidate jobs are ranked according to their VTS, where the best jobs for the member M will be at the top of the ranked list of candidate jobs. In some example embodiments, the machine-learning program is used to rank the jobs based on their VTS and S scores. The machine-learning program is trained with activity data of members of the social network, and then the member activity and the different job-related scores are used to rank the jobs for the member.

At operation 1314, a predetermined number of the top candidates is selected for presentation in the group area (e.g., group area 408) of the user interface. For example, six jobs may be presented per group (as long as there are six jobs available for each group), or a different number of jobs may be presented per group, such as a number in the range from one to ten. Further, in some example embodiments, groups with higher ranks may present more jobs than groups with lower ranks. For example, a top group may present ten jobs, and each of the remaining groups may present four jobs.

At operation 1316, the selected jobs are presented in the user interface. It is to be noted that the different groups are ranked according to their scores and then placed in the order of their ranking in the user interface.

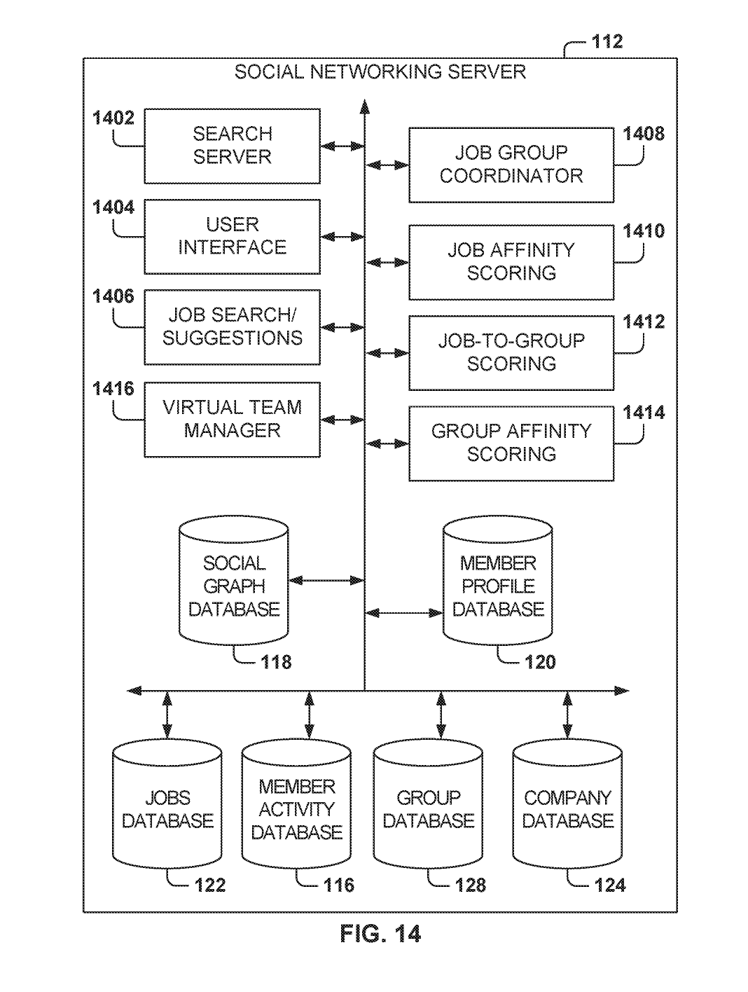

FIG. 14 illustrates a social networking server for implementing example embodiments. In one example embodiment, the social networking server 112 includes a search server 1402, a user interface module 1404, a job search/suggestions engine 1406, a virtual team manager 1416, a job group coordinator server 1408, a job affinity scoring server 1410, a job-to-group scoring server 1412, a group affinity scoring server 1414, and a plurality of databases, which include the social graph database 118, the member profile database 120, the jobs database 122, the member activity database 116, the group database 128, and the company database 124.

The search server 1402 performs data searches on the social network, such as searches for members or companies. In some example embodiments, the search server 1402 includes a machine-learning algorithm for performing the searches that utilizes a plurality of features for selecting and scoring the jobs. The features include, at least, one or more of: title, industry, skills, member profile, company profile, job title, job data, region, and salary range. The user interface module 1404 communicates with the client devices 104 to exchange user interface data for presenting the user interface to the user. The job search/suggestions engine 1406 performs job searches based on a search query (e.g., using one or more keywords and a geographic location as illustrated in FIG. 4) or based on a member profile in order to offer job suggestions.

The virtual team manager 1416 determines the composition of the virtual teams, e.g., who are the members that belong in each virtual team for the different companies. The job affinity scoring server 1410 calculates the job affinity scores, as illustrated above with reference to FIGS. 12A-12B. The job-to-group scoring server 1412 calculates the job-to-group scores, as illustrated above with reference to FIGS. 12B and 13. The group affinity scoring server 1414 calculates the group affinity scores, as illustrated above with reference to FIGS. 12B and 13.

The job group coordinator server 1408 calculates the combined score for the scores identified above. The job group coordinator server 1408 further ranks the different groups in order to determine the priority of presentation of the groups in the user interface, and which groups will be presented or omitted. In addition, the job group coordinator server 1408 may determine in which group to present a job, if the job could be presented in two or more groups.

It is to be noted that the embodiments illustrated in FIG. 14 are examples and do not describe every possible embodiment. Other embodiments may utilize different servers or additional servers, combine the functionality of two or more servers into a single server, utilize a distributed server pool, and so forth. The embodiments illustrated in FIG. 14 should therefore not be interpreted to be exclusive or limiting, but rather illustrative.

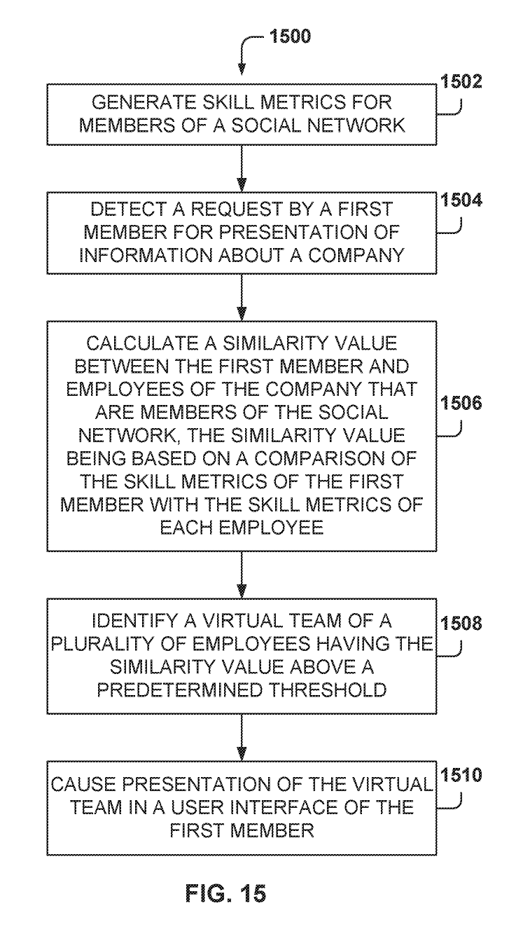

FIG. 15 is a flowchart of a method 1500, according to some example embodiments, for finding a virtual team in a company based on the skills of a member in the social network, such that the virtual team members have similar skills to the skills of the member.

At operation 1502, the method 1500 generates skill metrics for members of a social network. From operation 1502, the method 1500 flows to operation 1504, where a request is detected by a first member for presenting information about a company (see, for example, the user interfaces of FIGS. 5-7).

From operation 1504, the method 1500 flows to operation 1506 for calculating a similarity value between the first member and employees of the company that are members of the social network. The similarity value is based on a comparison of the skill metrics of the first member with the skill metrics of each employee.

At operation 1508, the method 1500 identifies a virtual team of a plurality of employees having the similarity value above a predetermined threshold. From operation 1508, the method 1500 flows to operation 1510 for causing presentation of the virtual team in a user interface of the first member.

In some examples, the skill metrics include a vector formed by aggregating a skill vector for each skill of the member, the skill vector including values calculated by a machine-learning program, where similar skills have similar skill vectors. Further, the similarity value is calculated as a cosine similarity between two skill vectors.

In another example, the skill metrics include a vector formed by aggregating a title vector of the member and a skill vector for each skill of the member, the title vector and the skill vector having respective values calculated by a machine-learning program, where similar skills have similar skill vectors and similar titles have similar title vectors.

In yet another example, the similarity is calculated by a machine-learning program trained with skill data for the members of the social network, the machine-learning program calculating the similarity value for a pair of members such that the similarity value is correlated to a similarity of skills between the pair of members.

In another example, the request is for information about the company, where the virtual team is presented with the information about the company.

In one example, the request is for information about a job in the company, where the virtual team is presented with the information about the job in the company.

In another example, each member is associated with a member profile containing a plurality of skills and endorsements for each skill.

In another example, the method 1500 as recited further includes presenting in the user interface information about commonality of skills between the first member and members in the virtual team, where three to six members in the virtual team are presented in the user interface.

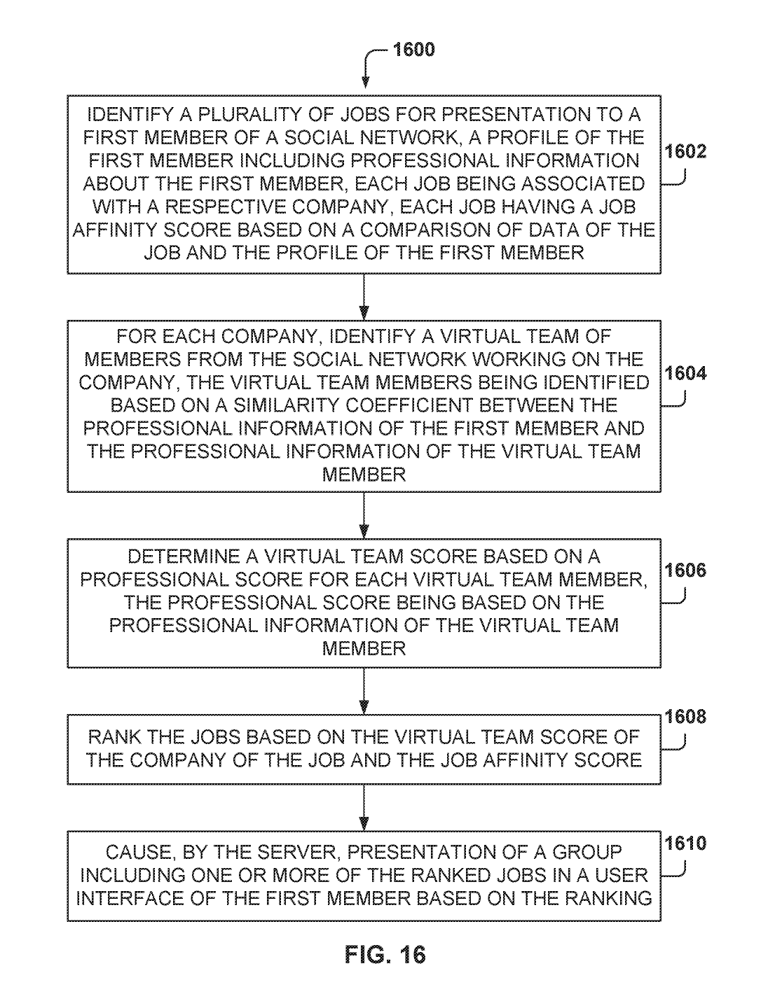

FIG. 16 is a flowchart of a method 1600, according to some example embodiments, for searching job postings for a member of a social network based on the strength of virtual teams at the companies offering the jobs. Operation 1602 is for identifying, by a server having one or more processors, a plurality of jobs for presentation to a first member of a social network. A profile of the first member includes professional information about the first member, where each job is associated with a respective company, and each job has a job affinity score based on a comparison of data of the job and the profile of the first member.

From operation 1602, the method 1600 flows to operation 1604, where for each company, a virtual team of members from the social network working on the company is identified. The virtual team members are identified based on a similarity coefficient between the professional information of the first member and the professional information of the virtual team member.

From operation 1604, the method 1600 flows to operation 1606 for determining a virtual team score based on a professional score for each virtual team member. The professional score is based on the professional information of the virtual team member. At operation 1608, the server ranks the jobs based on the virtual team score of the company of the job and the job affinity score, and in operation 1610, the server causes presentation of a group including one or more of the ranked jobs in a user interface of the first member based on the ranking.

In one example, the professional score is calculated based on professional accomplishments of the virtual team member. In another example, the professional accomplishments are selected from a group including a number of years of experience, number of published papers, number of patents obtained, number of companies founded, number of followers in a social network, and a score for the company where the virtual team member works.

In one example, determining the virtual team score further includes calculating a weighted average of the professional scores of the virtual team members, where virtual team members with higher professional scores have higher weights than virtual team members with lower professional scores.

In one example, identifying the virtual team further includes generating skill metrics for members of the social network.

The method 1600 may also include calculating a similarity value between the first member and employees of the company that are members of the social network. The similarity value is based on a comparison of the skill metrics of the first member with the skill metric of each employee.

In another example, the method 1600 may also include identifying virtual team members that have a similarity value above a predetermined threshold.

In one aspect, determining the job affinity score is performed by a machine-learning program based on the data of the job and the profile of the first member, the machine-learning program being trained utilizing data of job postings in the social network and data of members of the social network.

In another example, the user interface for presenting the group further includes a header message for virtual team presentation and presentation of a plurality of virtual teams and respective virtual team members.

In another aspect, the user interface for presentation of the group presents a predetermined number of jobs at a time with an option for scrolling to see additional jobs.

In one example, the user interface further presents additional groups, where the groups are sorted based on respective job affinity scores of jobs within each group, group affinity scores for each group, and job-to-group scores for each group.

In another example, the method 1600 as recited further includes calculating a group affinity score for the first member based on interactions of the first member related to job searches or job applications for a plurality of companies.

While the various operations in flowcharts of FIGS. 14 and 15 are presented and described sequentially, one of ordinary skill will appreciate that some or all of the operations may be executed in a different order, be combined or omitted, or be executed in parallel.

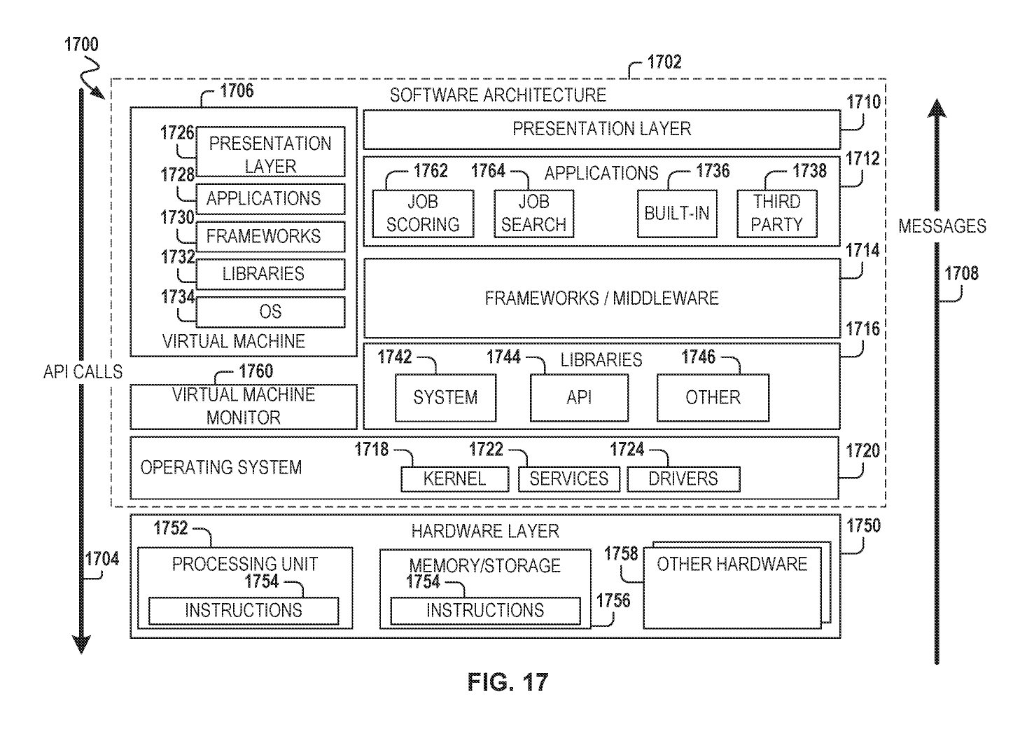

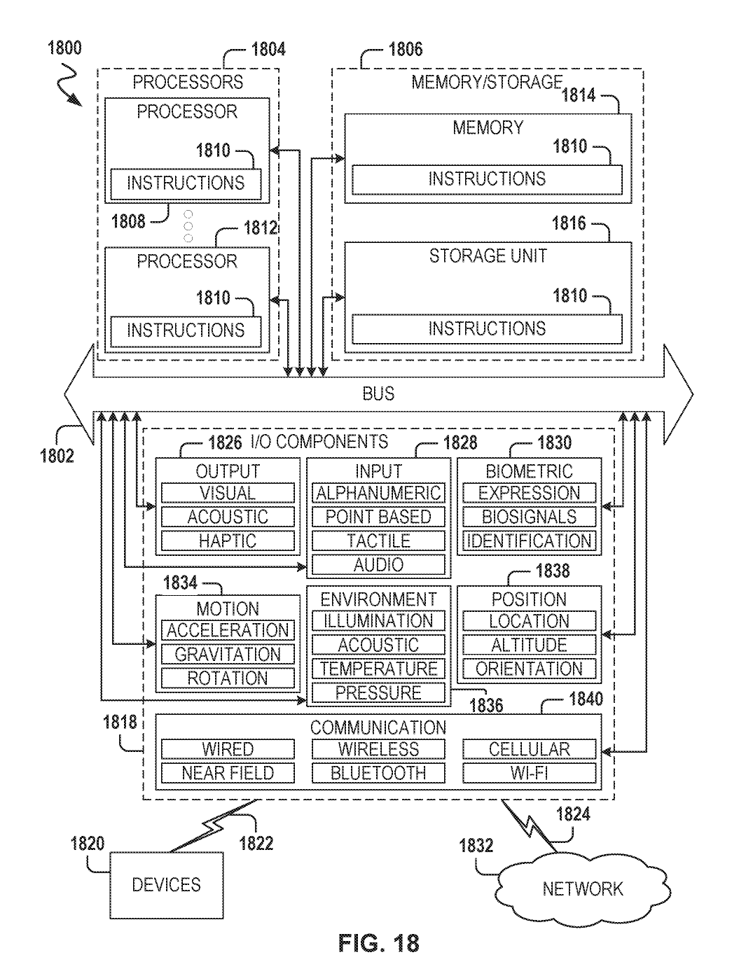

FIG. 17 is a block diagram 1700 illustrating a representative software architecture 1702, which may be used in conjunction with various hardware architectures herein described. FIG. 17 is merely a non-limiting example of a software architecture 1702, and it will be appreciated that many other architectures may be implemented to facilitate the functionality described herein. The software architecture 1702 may be executing on hardware such as a machine 1800 of FIG. 18 that includes, among other things, processors 1804, memory/storage 1806, and input/output (I/O) components 1818. A representative hardware layer 1750 is illustrated and can represent, for example, the machine 1800 of FIG. 18. The representative hardware layer 1750 comprises one or more processing units 1752 having associated executable instructions 1754. The executable instructions 1754 represent the executable instructions of the software architecture 1702, including implementation of the methods, modules, and so forth of FIGS. 1-6, 8, and 10-12. The hardware layer 1750 also includes memory and/or storage modules 1756, which also have the executable instructions 1754. The hardware layer 1750 may also comprise other hardware 1758, which represents any other hardware of the hardware layer 1750, such as the other hardware illustrated as part of the machine 1800.

In the example architecture of FIG. 17, the software architecture 1702 may be conceptualized as a stack of layers where each layer provides particular functionality. For example, the software architecture 1702 may include layers such as an operating system 1720, libraries 1716, frameworks/middleware 1714, applications 1712, and a presentation layer 1710. Operationally, the applications 1712 and/or other components within the layers may invoke application programming interface (API) calls 1704 through the software stack and receive a response, returned values, and so forth illustrated as messages 1708 in response to the API calls 1704. The layers illustrated are representative in nature, and not all software architectures have all layers. For example, some mobile or special-purpose operating systems may not provide a frameworks/middleware layer 1714, while others may provide such a layer. Other software architectures may include additional or different layers.

The operating system 1720 may manage hardware resources and provide common services. The operating system 1720 may include, for example, a kernel 1718, services 1722, and drivers 1724. The kernel 1718 may act as an abstraction layer between the hardware and the other software layers. For example, the kernel 1718 may be responsible for memory management, processor management (e.g., scheduling), component management, networking, security settings, and so on. The services 1722 may provide other common services for the other software layers. The drivers 1724 may be responsible for controlling or interfacing with the underlying hardware. For instance, the drivers 1724 may include display drivers, camera drivers, Bluetooth® drivers, flash memory drivers, serial communication drivers (e.g., Universal Serial Bus (USB) drivers). Wi-Fi® drivers, audio drivers, power management drivers, and so forth depending on the hardware configuration.

The libraries 1716 may provide a common infrastructure that may be utilized by the applications 1712 and/or other components and/or layers. The libraries 1716 typically provide functionality that allows other software modules to perform tasks in an easier fashion than by interfacing directly with the underlying operating system 1720 functionality (e.g., kernel 1718, services 1722, and/or drivers 1724). The libraries 1716 may include system libraries 1742 (e.g., C standard library) that may provide functions such as memory allocation functions, string manipulation functions, mathematic functions, and the like. In addition, the libraries 1716 may include API libraries 1744 such as media libraries (e.g., libraries to support presentation and manipulation of various media formats such as MPEG4. H.264, MP3, AAC, AMR, JPG, PNG), graphics libraries (e.g., an OpenGL framework that may be used to render two-dimensional and three-dimensional graphic content on a display), database libraries (e.g., SQLite that may provide various relational database functions), web libraries (e.g., WebKit that may provide web browsing functionality), and the like. The libraries 1716 may also include a wide variety of other libraries 1746 to provide many other APIs to the applications 1712 and other software components/modules.

The frameworks 1714 (also sometimes referred to as middleware) may provide a higher-level common infrastructure that may be utilized by the applications 1712 and/or other software components/modules. For example, the frameworks 1714 may provide various graphic user interface (GUI) functions, high-level resource management, high-level location services, and so forth. The frameworks 1714 may provide a broad spectrum of other APIs that may be utilized by the applications 1712 and/or other software components/modules, some of which may be specific to a particular operating system or platform.

The applications 1712 include job-scoring applications 1762, job search/suggestions 1764, built-in applications 1736, and third-party applications 1738. The job-scoring applications 1762 comprise the job-scoring applications as discussed above with reference to FIG. 14. Examples of representative built-in applications 1736 may include, but are not limited to, a contacts application, a browser application, a book reader application, a location application, a media application, a messaging application, and/or a game application. The third-party applications 1738 may include any of the built-in applications 1736 as well as a broad assortment of other applications. In a specific example, the third-party applications 1738 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party applications 1738 may invoke the API calls 1704 provided by the mobile operating system such as the operating system 1720 to facilitate functionality described herein.

The applications 1712 may utilize built-in operating system functions (e.g., kernel 1718, services 1722, and/or drivers 1724), libraries (e.g., system libraries 1742, API libraries 1744, and other libraries 1746), or frameworks/middleware 1714 to create user interfaces to interact with users of the system. Alternatively, or additionally, in some systems, interactions with a user may occur through a presentation layer, such as the presentation layer 1710. In these systems, the application/module “logic” can be separated from the aspects of the application/module that interact with a user.

Some software architectures utilize virtual machines. In the example of FIG. 17, this is illustrated by a virtual machine 1706. A virtual machine creates a software environment where applications/modules can execute as if they were executing on a hardware machine (such as the machine 1800 of FIG. 18, for example). The virtual machine 1706 is hosted by a host operating system (e.g., operating system 1720 in FIG. 17) and typically, although not always, has a virtual machine monitor 1760, which manages the operation of the virtual machine 1706 as well as the interface with the host operating system (e.g., operating system 1720). A software architecture executes within the virtual machine 1706, such as an operating system 1734, libraries 1732, frameworks/middleware 1730, applications 1728, and/or a presentation layer 1726. These layers of software architecture executing within the virtual machine 1706 can be the same as corresponding layers previously described or may be different.

FIG. 18 is a block diagram illustrating components of a machine 1800, according to some example embodiments, able to read instructions from a machine-readable medium (e.g., a machine-readable storage medium) and perform any one or more of the methodologies discussed herein. Specifically, FIG. 18 shows a diagrammatic representation of the machine 1800 in the example form of a computer system, within which instructions 1810 (e.g., software, a program, an application, an applet, an app, or other executable code) for causing the machine 1800 to perform any one or more of the methodologies discussed herein may be executed. For example, the instructions 1810 may cause the machine 1800 to execute the flow diagrams of FIGS. 15 and 16. Additionally, or alternatively, the instructions 1810 may implement the job-scoring programs and the machine-learning programs associated with them. The instructions 1810 transform the general, non-programmed machine 1800 into a particular machine 1800 programmed to carry out the described and illustrated functions in the manner described.

In alternative embodiments, the machine 1800 operates as a standalone device or may be coupled (e.g., networked) to other machines. In a networked deployment, the machine 1800 may operate in the capacity of a server machine or a client machine in a server-client network environment, or as a peer machine in a peer-to-peer (or distributed) network environment. The machine 1800 may comprise, but not be limited to, a switch, a controller, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1810, sequentially or otherwise, that specify actions to be taken by the machine 1800. Further, while only a single machine 1800 is illustrated, the term “machine” shall also be taken to include a collection of machines 1800 that individually or jointly execute the instructions 1810 to perform any one or more of the methodologies discussed herein.

The machine 1800 may include processors 1804, memory/storage 1806, and I/O components 1818, which may be configured to communicate with each other such as via a bus 1802. In an example embodiment, the processors 1804 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1808 and a processor 1812 that may execute the instructions 1810. The term “processor” is intended to include multi-core processors that may comprise two or more independent processors (sometimes referred to as “cores”) that may execute instructions contemporaneously. Although FIG. 18 shows multiple processors 1804, the machine 1800 may include a single processor with a single core, a single processor with multiple cores (e.g., a multi-core processor), multiple processors with a single core, multiple processors with multiples cores, or any combination thereof.

The memory/storage 1806 may include a memory 1814, such as a main memory, or other memory storage, and a storage unit 1816, both accessible to the processors 1804 such as via the bus 1802. The storage unit 1816 and memory 1814 store the instructions 1810 embodying any one or more of the methodologies or functions described herein. The instructions 1810 may also reside, completely or partially, within the memory 1814, within the storage unit 1816, within at least one of the processors 1804 (e.g., within the processor's cache memory), or any suitable combination thereof, during execution thereof by the machine 1800. Accordingly, the memory 1814, the storage unit 1816, and the memory of the processors 1804 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1810. The term “machine-readable medium” shall also be taken to include any medium, or combination of multiple media, that is capable of storing instructions (e.g., instructions 1810) for execution by a machine (e.g., machine 1800), such that the instructions, when executed by one or more processors of the machine (e.g., processors 1804), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1818 may include a wide variety of components to receive input, provide output, produce output, transmit information, exchange information, capture measurements, and so on. The specific I/O components 1818 that are included in a particular machine will depend on the type of machine. For example, portable machines such as mobile phones will likely include a touch input device or other such input mechanisms, while a headless server machine will likely not include such a touch input device. It will be appreciated that the I/O components 1818 may include many other components that are not shown in FIG. 18. The I/O components 1818 are grouped according to functionality merely for simplifying the following discussion, and the grouping is in no way limiting. In various example embodiments, the I/O components 1818 may include output components 1826 and input components 1828. The output components 1826 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1828 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 1818 may include biometric components 1830, motion components 1834, environmental components 1836, or position components 1838 among a wide array of other components. For example, the biometric components 1830 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1834 may include acceleration sensor components (e.g., accelerometer), gravitation sensor components, rotation sensor components (e.g., gyroscope), and so forth. The environmental components 1836 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1838 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1818 may include communication components 1840 operable to couple the machine 1800 to a network 1832 or devices 1820 via a coupling 1824 and a coupling 1822, respectively. For example, the communication components 1840 may include a network interface component or other suitable device to interface with the network 1832. In further examples, the communication components 1840 may include wired communication components, wireless communication components, cellular communication components, Near Field Communication (NFC) components, Bluetooth® components (e.g., Bluetooth® Low Energy). Wi-Fi® components, and other communication components to provide communication via other modalities. The devices 1820 may be another machine or any of a wide variety of peripheral devices (e.g., a peripheral device coupled via a USB).

Moreover, the communication components 1840 may detect identifiers or include components operable to detect identifiers. For example, the communication components 1840 may include Radio Frequency Identification (RFID) tag reader components. NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1840, such as location via Internet Protocol (IP) geo-location, location via Wi-Fi® signal triangulation, location via detecting an NFC beacon signal that may indicate a particular location, and so forth.

In various example embodiments, one or more portions of the network 1832 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1832 or a portion of the network 1832 may include a wireless or cellular network and the coupling 1824 may be a Code Division Multiple Access (CDMA) connection, a Global System for Mobile communications (GSM) connection, or another type of cellular or wireless coupling. In this example, the coupling 1824 may implement any of a variety of types of data transfer technology, such as Single Carrier Radio Transmission Technology (1×RTT). Evolution-Data Optimized (EVDO) technology, General Packet Radio Service (GPRS) technology. Enhanced Data rates for GSM Evolution (EDGE) technology, third Generation Partnership Project (3GPP) including 3G, fourth generation wireless (4G) networks. Universal Mobile Telecommunications System (UMTS), High Speed Packet Access (HSPA), Worldwide Interoperability for Microwave Access (WiMAX). Long Term Evolution (LTE) standard, others defined by various standard-setting organizations, other long range protocols, or other data transfer technology.

The instructions 1810 may be transmitted or received over the network 1832 using a transmission medium via a network interface device (e.g., a network interface component included in the communication components 1840) and utilizing any one of a number of well-known transfer protocols (e.g., hypertext transfer protocol (HTTP)). Similarly, the instructions 1810 may be transmitted or received using a transmission medium via the coupling 1822 (e.g., a peer-to-peer coupling) to the devices 1820. The term “transmission medium” shall be taken to include any intangible medium that is capable of storing, encoding, or carrying the instructions 1810 for execution by the machine 1800, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
generating, by one or more processors, skill metrics for members of a social network;
detecting a request by a first member for presentation of information about a company;
calculating, by the one or more processors, a similarity value between the first member and employees of the company that are members of the social network, the similarity value being based on a comparison of the skill metrics of the first member with the skill metrics of each employee;
identifying, by the one or more processors, a virtual team of a plurality of employees having the similarity value above a predetermined threshold; and
causing presentation of the virtual team in a user interface of the first member.

2. The method as recited in claim 1, wherein the skill metrics comprise a vector formed by aggregating a skill vector for each skill of the member, the skill vector including values calculated by a machine-learning program, wherein similar skills have similar skill vectors.

3. The method as recited in claim 2, wherein the similarity value is calculated as a cosine similarity between two skill vectors.

4. The method as recited in claim 1, wherein the skill metrics comprise a vector formed by aggregating a title vector of the member and a skill vector for each skill of the member, the title vector and the skill vector having respective values calculated by a machine-learning program, wherein similar skills have similar skill vectors and similar titles have similar title vectors.

5. The method as recited in claim 1, wherein the similarity value is calculated by a machine-learning program trained with skill data for the members of the social network, the machine-learning program calculating the similarity value for a pair of members such that the similarity value is correlated to a similarity of skills between the pair of members.

6. The method as recited in claim 1, wherein the request is for information about the company, wherein the virtual team is presented with the information about the company.

7. The method as recited in claim 1, wherein the request is for information about a job in the company, wherein the virtual team is presented with the information about the job in the company.

8. The method as recited in claim 1, wherein each member is associated with a member profile containing a plurality of skills and endorsements for each skill.

9. The method as recited in claim 1, further comprising:
presenting in the user interface information about a commonality of skills between the first member and members in the virtual team.

10. The method as recited in claim 1, wherein three to six members in the virtual team are presented in the user interface.

11. A system comprising:
a memory comprising instructions; and
one or more computer processors, wherein the instructions, when executed by the one or more computer processors, cause the one or more computer processors to perform operations comprising:
generating skill metrics for members of a social network;
detecting a request by a first member for presentation of information about a company;
calculating a similarity value between the first member and employees of the company that are members of the social network, the similarity value being based on a comparison of the skill metrics of the first member with the skill metrics of each employee;
identifying a virtual team of a plurality of employees having the similarity value above a predetermined threshold; and
causing presentation of the virtual team in a user interface of the first member.

12. The system as recited in claim 11, wherein the skill metrics comprise a vector formed by aggregating a skill vector for each skill of the member, the skill vector including values calculated by a machine-learning program, wherein similar skills have similar skill vectors.

13. The system as recited in claim 12, wherein the similarity value is calculated as a cosine similarity between two skill vectors.

14. The system as recited in claim 11, wherein the skill metrics comprise a vector formed by aggregating a title vector of the member and a skill vector for each skill of the member, the title vector and the skill vector having respective values calculated by a machine-learning program, wherein similar skills have similar skill vectors and similar titles have similar title vectors.

15. The system as recited in claim 11, wherein the similarity value is calculated by a machine-learning program trained with skill data for the members of the social network, the machine-learning program calculating the similarity value for a pair of members such that the similarity value is correlated to a similarity of skills between the pair of members.

16. A non-transitory machine-readable storage medium including instructions that, when executed by a machine, cause the machine to perform operations comprising:
generating skill metrics for members of a social network;
detecting a request by a first member for presentation of information about a company;
calculating a similarity value between the first member and employees of the company that are members of the social network, the similarity value being based on a comparison of the skill metrics of the first member with the skill metrics of each employee;
identifying a virtual team of a plurality of employees having the similarity value above a predetermined threshold; and
causing presentation of the virtual team in a user interface of the first member.

17. The machine-readable storage medium as recited in claim 16, wherein the skill metrics comprise a vector formed by aggregating a skill vector for each skill of the member, the skill vector including values calculated by a machine-learning program, wherein similar skills have similar skill vectors.

18. The machine-readable storage medium as recited in claim 16, wherein the skill metrics comprise a vector formed by aggregating a title vector of the member and a skill vector for each skill of the member, the title vector and the skill vector having respective values calculated by a machine-learning program, wherein similar skills have similar skill vectors and similar titles have similar title vectors.

19. The machine-readable storage medium as recited in claim 16, wherein the similarity value is calculated by a machine-learning program trained with skill data for the members of the social network, the machine-learning program calculating the similarity value for a pair of members such that the similarity value is correlated to a similarity of skills between the pair of members.

20. The machine-readable storage medium as recited in claim 16, wherein the request is for information about a job in the company, wherein the virtual team is presented with the information about the job in the company.
